(19) United States
(12) Patent Application Publication
(10) Pub. No.: US 2024/0123944 A1
(43) Pub. Date: Apr. 18, 2024

(54) DEVICES, SYSTEMS, AND METHODS FOR CAMERA CLEANING AND FLARE REDUCTION FOR VEHICLES

(71) Applicant: Motional AD LLC, Boston, MA (US)

(72) Inventors: Lin Luo, South San Francisco, CA (US); Arthur Safira, Boston, MA (US); Ting Wang, Rancho Palos Verdes, CA (US)

(21) Appl. No.: 18/148,321

(22) Filed: Dec. 29, 2022

Related U.S. Application Data
(60) Provisional application No. 63/379,588, filed on Oct. 14, 2022.

(51) Int. Cl. B60S 1/08; B60S 1/54; B60S 1/56

(52) U.S. Cl. CPC B60S 1/0818; B60S 1/542; B60S 1/56

(57) ABSTRACT

Provided are devices for camera cleaning and flare reduction for vehicles, which can include a cleaning device for cleaning a transparent window of a housing containing a camera system. The devices can include optical panels with different properties that can be moved in front of the transparent window for flare reduction. Methods are provided which can include analyzing at least one image to determine a presence of an optical flare within the at least one image, and, based on detecting the optical flare, causing at least one optical panel to be moved into a position in front of a lens of the imaging device. Computer program products are also provided.

### PRIORITY APPLICATION

The present application is claims priority to U.S. Provisional Application No. 63/379,588, filed Oct. 14, 2022, which is incorporated herein by reference. Any and all applications for which a foreign or domestic priority claim is identified in the Application Data Sheet as filed with the present application are hereby incorporated by reference under 37 CFR 1.57.

### BACKGROUND

The present application is directed to sensors, such as cameras, for vehicles. Some embodiments relate to devices, systems, and methods for camera cleaning and flare reduction for cameras of vehicles. In some embodiments, the vehicles are self-driving or autonomous vehicles.

### BRIEF DESCRIPTION OF THE FIGURES

FIG. 1 is an example environment in which a vehicle including one or more components of an autonomous system can be implemented;

FIG. 2 is a diagram of one or more systems of a vehicle including an autonomous system;

FIG. 3 is a diagram of components of one or more devices and/or one or more systems of FIGS. 1 and 2;

FIG. 4 is a diagram of certain components of an autonomous system;

FIG. 5A illustrates an embodiment of a system comprising an imaging device and a cleaning device;

FIG. 5B illustrates another embodiment of a system comprising an imaging device and a cleaning device;

FIG. 6A illustrates an embodiment of a system comprising an imaging device and a flare protection or reduction device;

FIG. 6B illustrates another embodiment of a system comprising an imaging device and a flare protection or reduction device shown in a first state;

FIG. 6C illustrates the system of FIG. 6B in a second state;

FIG. 6D illustrates another embodiment of a system comprising an imaging device and a flare protection or reduction device;

FIG. 7A illustrates an embodiment of a system comprising an imaging device and a visor shown in a first state;

FIG. 7B illustrates the system of FIG. 7A in a second state;

FIG. 8A is a flowchart of a process for flare reduction for an imaging device;

FIG. 8B is a flowchart of a process for cleaning an imaging device;

FIG. 9A is a flowchart of a process for moving a visor for flare reduction for an imaging device;

FIG. 9B is a flowchart for a process for moving an optical panel for flare reduction for an imaging device; and

FIG. 9C is a flowchart for a process for operating a cleaning device to clean an imaging device.

### DETAILED DESCRIPTION

In the following description numerous specific details are set forth in order to provide a thorough understanding of the present disclosure for the purposes of explanation. It will be apparent, however, that the embodiments described by the present disclosure can be practiced without these specific details. In some instances, well-known structures and devices are illustrated in block diagram form in order to avoid unnecessarily obscuring aspects of the present disclosure.

Specific arrangements or orderings of schematic elements, such as those representing systems, devices, modules, instruction blocks, data elements, and/or the like are illustrated in the drawings for ease of description. However, it will be understood by those skilled in the art that the specific ordering or arrangement of the schematic elements in the drawings is not meant to imply that a particular order or sequence of processing, or separation of processes, is required unless explicitly described as such. Further, the inclusion of a schematic element in a drawing is not meant to imply that such element is required in all embodiments or that the features represented by such element may not be included in or combined with other elements in some embodiments unless explicitly described as such.

Further, where connecting elements such as solid or dashed lines or arrows are used in the drawings to illustrate a connection, relationship, or association between or among two or more other schematic elements, the absence of any such connecting elements is not meant to imply that no connection, relationship, or association can exist. In other words, some connections, relationships, or associations between elements are not illustrated in the drawings so as not to obscure the disclosure. In addition, for ease of illustration, a single connecting element can be used to represent multiple connections, relationships or associations between elements. For example, where a connecting element represents communication of signals, data, or instructions (e.g., “software instructions”), it should be understood by those skilled in the art that such element can represent one or multiple signal paths (e.g., a bus), as may be needed, to affect the communication.

Although the terms first, second, third, and/or the like are used to describe various elements, these elements should not be limited by these terms. The terms first, second, third, and/or the like are used only to distinguish one element from another. For example, a first contact could be termed a second contact and, similarly, a second contact could be termed a first contact without departing from the scope of the described embodiments. The first contact and the second contact are both contacts, but they are not the same contact.

The terminology used in the description of the various described embodiments herein is included for the purpose of describing particular embodiments only and is not intended to be limiting. As used in the description of the various described embodiments and the appended claims, the singular forms “a,” “an” and “the” are intended to include the plural forms as well and can be used interchangeably with “one or more” or “at least one,” unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this description specify the presence of stated features, integers, steps, operations, elements, and/or components, but do not preclude the presence or addition of one or more other features, integers, steps, operations, elements, components, and/or groups thereof.

As used herein, the terms “communication” and “communicate” refer to at least one of the reception, receipt, transmission, transfer, provision, and/or the like of information (or information represented by, for example, data, signals, messages, instructions, commands, and/or the like). For one unit (e.g., a device, a system, a component of a device or system, combinations thereof, and/or the like) to be in communication with another unit means that the one unit is able to directly or indirectly receive information from and/or send (e.g., transmit) information to the other unit. This may refer to a direct or indirect connection that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit (e.g., a third unit located between the first unit and the second unit) processes information received from the first unit and transmits the processed information to the second unit. In some embodiments, a message may refer to a network packet (e.g., a data packet and/or the like) that includes data.

As used herein, the term “if” is, optionally, construed to mean “when,” “upon,” “in response to determining,” “in response to detecting,” and/or the like, depending on the context. Similarly, the phrase “if it is determined” or “if [a stated condition or event] is detected” is, optionally, construed to mean “upon determining,” “in response to determining,” “upon detecting [the stated condition or event],” “in response to detecting [the stated condition or event],” and/or the like, depending on the context. Also, as used herein, the terms “has,” “have,” “having,” or the like are intended to be open-ended terms. Further, the phrase “based on” is intended to mean “based at least partially on” unless explicitly stated otherwise.

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments can be practiced without these specific details. In other instances, well-known methods, procedures, components, circuits, and networks have not been described in detail so as not to unnecessarily obscure aspects of the embodiments.

General Overview

In some aspects and/or embodiments, systems, methods, and computer program products described herein include and/or implement camera (or other sensor) cleaning and flare reduction and protection for cameras of vehicles, such as autonomous or self-driving vehicles.

Autonomous or self-driving vehicles often include one or more image sensors or cameras (as well as other types of sensors) for detecting objects within the environment of the vehicles. Such image sensors or cameras can also be included on traditional vehicles (e.g., non-autonomous or non-self-driving vehicles). During operation of the vehicles, the image sensors or cameras are exposed to the environment. A lens of the image sensor or camera can be impacted by dirt, dust, rain, stones, exhaust, insects, or the like, which can impair the ability of the image sensor or the camera to capture clear images and videos.

As described herein, the camera can be protected by positioning the camera within a housing that protects the camera from the environment. The housing can include at least one transparent window through which the camera captures images and videos. The housing can shield or otherwise protect the camera from the environment to prevent degradation of the camera. In some embodiments, the housing can be connected to an environmental control system, such that the temperature, humidity, or other characteristics of the air within the housing can be regulated. Regulating the air within the housing can thereby regulate characteristics of the air in which the camera operates, which can, for example, improve performance of the camera by preventing the camera from overheating or being exposed to excessively high or low temperatures.

In some embodiments, the housing may include one or more cleaning devices that are operable to clean the transparent window of the housing, thus providing a clean window through which the camera can capture images and videos. For example, during use, the transparent window of the housing can be impacted dirt, dust, rain, stones, exhaust, insects, or the like. The one or more cleaning devices can be operated to clean the dirt, dust, rain, stones, exhaust, insects, or the like from the transparent window. In some embodiments, the cleaning device can include a wiper that is actuated to clean the window. In some embodiments, the cleaning device can include a nozzle configured to direct a jet of air, water, or other gases of fluids onto the transparent window to clean the window. Other cleaning devices are also possible.

In some instances, actuation of the cleaning device can by triggered based on an analysis of an image captured by the camera through the transparent window. For example, the image can be analyzed to determine a cleanliness state of the window. If the cleanliness state falls below a threshold, the cleaning device can be actuated to clean the window. In some instances, the cleaning device can be configured such that it is activated periodically (e.g., after a certain number of minutes, hours, days, etc.) so as to maintain the window in a sufficiently clean state. In some embodiments, the cleaning device can be triggered manually.

In some embodiments, the housing can include one or more optical panels that can be selectively moved in front of the lens of the camera. The optical panels may be transparent such that the camera captures images and videos through the optical panels. The optical panels can further be configured with different optical properties to provide various functionality. For example, in some embodiments, the optical panels can include clear, tinted, anti-glare, or photochromatic-adapted glass or plastic panels, or the like. The optical panels can be moved in front of the lens of the camera to adjust the image captured by the camera. For example, if the image includes a flare artifact, an anti-glare panel can be used to reduce the flare. As another example, if the image is too bright, a tinted panel can be used to reduce the brightness.

In some instances, selection and movement of the optical panels in front of the lens of the camera can by triggered based on an analysis of an image captured by the camera. For example, the image can be analyzed to determine the presence of a flare within the image. Upon detecting a flare, an appropriate optical panel can be moved in front of the lens of the camera. In some embodiments, the movement of the optical panels can be triggered manually.

By virtue of the implementation of systems, methods, and computer program products described herein, techniques for camera cleaning and flare reduction and protection for cameras of vehicles various advantages can be achieved. For example, the image quality of images captured by the cameras can be improved and or maintained at a sufficient quality level. The images captured by the cameras are generally analyzed to determine the presence of objects in the environment of the car, such as pedestrians, street signs, other vehicles, and the like. Thus, it can be quite important that the quality of the images is maintained as high as possible to ensure safe operation of the vehicle. These considerations can be especially important for self-driving and autonomous vehicles to ensure safe operation.

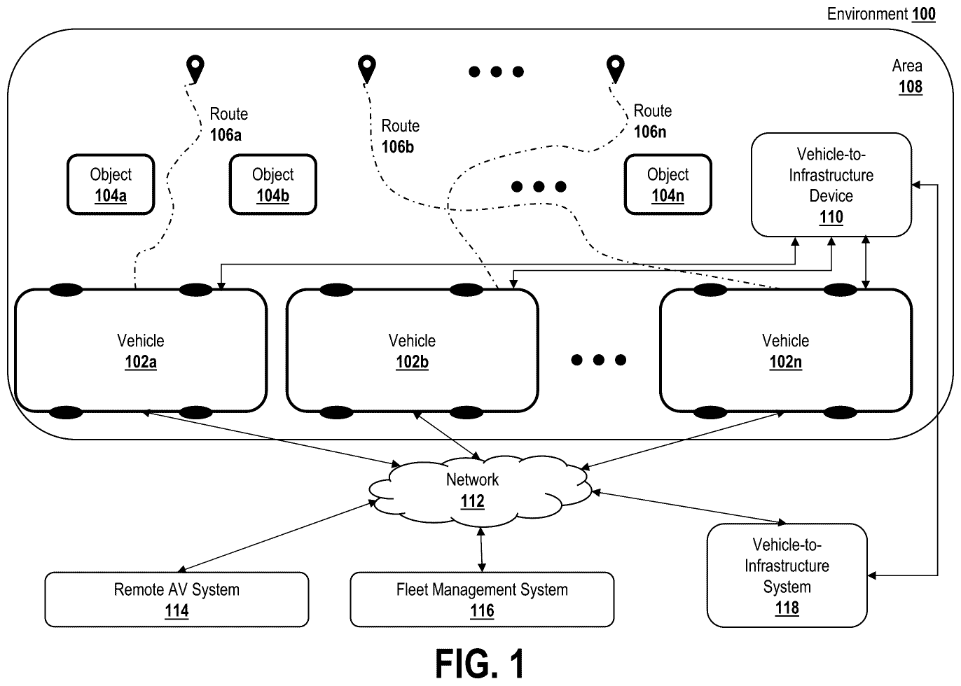

Referring now to FIG. 1, illustrated is example environment 100 in which vehicles that include autonomous systems, as well as vehicles that do not, are operated. As illustrated, environment 100 includes vehicles 102a-102n, objects 104a-104n, routes 106a-106n, area 108, vehicle-to-infrastructure (V2I) device 110, network 112, remote autonomous vehicle (AV) system 114, fleet management system 116, and V2I system 118. Vehicles 102a-102n, vehicle-to-infrastructure (V2I) device 110, network 112, autonomous vehicle (AV) system 114, fleet management system 116, and V2I system 118 interconnect (e.g., establish a connection to communicate and/or the like) via wired connections, wireless connections, or a combination of wired or wireless connections. In some embodiments, objects 104a-104n interconnect with at least one of vehicles 102a-102n, vehicle-to-infrastructure (V2I) device 110, network 112, autonomous vehicle (AV) system 114, fleet management system 116, and V2I system 118 via wired connections, wireless connections, or a combination of wired or wireless connections.

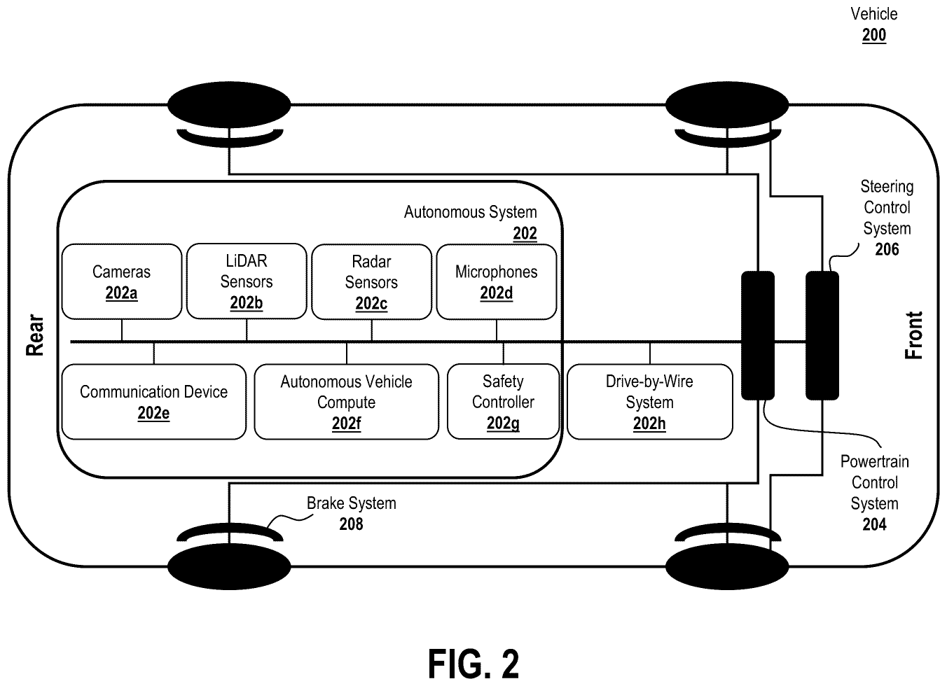

Vehicles 102a-102n (referred to individually as vehicle 102 and collectively as vehicles 102) include at least one device configured to transport goods and/or people. In some embodiments, vehicles 102 are configured to be in communication with V2I device 110, remote AV system 114, fleet management system 116, and/or V2I system 118 via network 112. In some embodiments, vehicles 102 include cars, buses, trucks, trains, and/or the like. In some embodiments, vehicles 102 are the same as, or similar to, vehicles 200, described herein (see FIG. 2). In some embodiments, a vehicle 200 of a set of vehicles 200 is associated with an autonomous fleet manager. In some embodiments, vehicles 102 travel along respective routes 106a-106n (referred to individually as route 106 and collectively as routes 106), as described herein. In some embodiments, one or more vehicles 102 include an autonomous system (e.g., an autonomous system that is the same as or similar to autonomous system 202).

Objects 104a-104n (referred to individually as object 104 and collectively as objects 104) include, for example, at least one vehicle, at least one pedestrian, at least one cyclist, at least one structure (e.g., a building, a sign, a fire hydrant, etc.), and/or the like. Each object 104 is stationary (e.g., located at a fixed location for a period of time) or mobile (e.g., having a velocity and associated with at least one trajectory). In some embodiments, objects 104 are associated with corresponding locations in area 108.

Routes 106a-106n (referred to individually as route 106 and collectively as routes 106) are each associated with (e.g., prescribe) a sequence of actions (also known as a trajectory) connecting states along which an AV can navigate. Each route 106 starts at an initial state (e.g., a state that corresponds to a first spatiotemporal location, velocity, and/or the like) and ends at a final goal state (e.g., a state that corresponds to a second spatiotemporal location that is different from the first spatiotemporal location) or goal region (e.g. a subspace of acceptable states (e.g., terminal states)). In some embodiments, the first state includes a location at which an individual or individuals are to be picked-up by the AV and the second state or region includes a location or locations at which the individual or individuals picked-up by the AV are to be dropped-off. In some embodiments, routes 106 include a plurality of acceptable state sequences (e.g., a plurality of spatiotemporal location sequences), the plurality of state sequences associated with (e.g., defining) a plurality of trajectories. In an example, routes 106 include only high level actions or imprecise state locations, such as a series of connected roads dictating turning directions at roadway intersections. Additionally, or alternatively, routes 106 may include more precise actions or states such as, for example, specific target lanes or precise locations within the lane areas and targeted speed at those positions. In an example, routes 106 include a plurality of precise state sequences along the at least one high level action sequence with a limited lookahead horizon to reach intermediate goals, where the combination of successive iterations of limited horizon state sequences cumulatively correspond to a plurality of trajectories that collectively form the high level route to terminate at the final goal state or region.

Area 108 includes a physical area (e.g., a geographic region) within which vehicles 102 can navigate. In an example, area 108 includes at least one state (e.g., a country, a province, an individual state of a plurality of states included in a country, etc.), at least one portion of a state, at least one city, at least one portion of a city, etc. In some embodiments, area 108 includes at least one named thoroughfare (referred to herein as a “road”) such as a highway, an interstate highway, a parkway, a city street, etc. Additionally, or alternatively, in some examples area 108 includes at least one unnamed road such as a driveway, a section of a parking lot, a section of a vacant and/or undeveloped lot, a dirt path, etc. In some embodiments, a road includes at least one lane (e.g., a portion of the road that can be traversed by vehicles 102). In an example, a road includes at least one lane associated with (e.g., identified based on) at least one lane marking.

Vehicle-to-Infrastructure (V2I) device 110 (sometimes referred to as a Vehicle-to-Infrastructure or Vehicle-to-Everything (V2X) device) includes at least one device configured to be in communication with vehicles 102 and/or V2I infrastructure system 118. In some embodiments, V2I device 110 is configured to be in communication with vehicles 102, remote AV system 114, fleet management system 116, and/or V2I system 118 via network 112. In some embodiments, V2I device 110 includes a radio frequency identification (RFID) device, signage, cameras (e.g., two-dimensional (2D) and/or three-dimensional (3D) cameras), lane markers, streetlights, parking meters, etc. In some embodiments, V2I device 110 is configured to communicate directly with vehicles 102. Additionally, or alternatively, in some embodiments V2I device 110 is configured to communicate with vehicles 102, remote AV system 114, and/or fleet management system 116 via V2I system 118. In some embodiments, V2I device 110 is configured to communicate with V2I system 118 via network 112.

Network 112 includes one or more wired and/or wireless networks. In an example, network 112 includes a cellular network (e.g., a long term evolution (LTE) network, a third generation (3G) network, a fourth generation (4G) network, a fifth generation (5G) network, a code division multiple access (CDMA) network, etc.), a public land mobile network (PLMN), a local area network (LAN), a wide area network (WAN), a metropolitan area network (MAN), a telephone network (e.g., the public switched telephone network (PSTN), a private network, an ad hoc network, an intranet, the Internet, a fiber optic-based network, a cloud computing network, etc., a combination of some or all of these networks, and/or the like.

Remote AV system 114 includes at least one device configured to be in communication with vehicles 102, V2I device 110, network 112, fleet management system 116, and/or V2I system 118 via network 112. In an example, remote AV system 114 includes a server, a group of servers, and/or other like devices. In some embodiments, remote AV system 114 is co-located with the fleet management system 116. In some embodiments, remote AV system 114 is involved in the installation of some or all of the components of a vehicle, including an autonomous system, an autonomous vehicle compute, software implemented by an autonomous vehicle compute, and/or the like. In some embodiments, remote AV system 114 maintains (e.g., updates and/or replaces) such components and/or software during the lifetime of the vehicle.

Fleet management system 116 includes at least one device configured to be in communication with vehicles 102, V2I device 110, remote AV system 114, and/or V2I infrastructure system 118. In an example, fleet management system 116 includes a server, a group of servers, and/or other like devices. In some embodiments, fleet management system 116 is associated with a ridesharing company (e.g., an organization that controls operation of multiple vehicles (e.g., vehicles that include autonomous systems and/or vehicles that do not include autonomous systems) and/or the like).

In some embodiments, V2I system 118 includes at least one device configured to be in communication with vehicles 102, V2I device 110, remote AV system 114, and/or fleet management system 116 via network 112. In some examples, V2I system 118 is configured to be in communication with V2I device 110 via a connection different from network 112. In some embodiments, V2I system 118 includes a server, a group of servers, and/or other like devices. In some embodiments, V2I system 118 is associated with a municipality or a private institution (e.g., a private institution that maintains V2I device 110 and/or the like).

The number and arrangement of elements illustrated in FIG. 1 are provided as an example. There can be additional elements, fewer elements, different elements, and/or differently arranged elements, than those illustrated in FIG. 1. Additionally, or alternatively, at least one element of environment 100 can perform one or more functions described as being performed by at least one different element of FIG. 1. Additionally, or alternatively, at least one set of elements of environment 100 can perform one or more functions described as being performed by at least one different set of elements of environment 100.

Referring now to FIG. 2, vehicle 200 (which may be the same as, or similar to vehicles 102 of FIG. 1) includes or is associated with autonomous system 202, powertrain control system 204, steering control system 206, and brake system 208. In some embodiments, vehicle 200 is the same as or similar to vehicle 102 (see FIG. 1). In some embodiments, autonomous system 202 is configured to confer vehicle 200 autonomous driving capability (e.g., implement at least one driving automation or maneuver-based function, feature, device, and/or the like that enable vehicle 200 to be partially or fully operated without human intervention including, without limitation, fully autonomous vehicles (e.g., vehicles that forego reliance on human intervention such as Level 5 ADS-operated vehicles), highly autonomous vehicles (e.g., vehicles that forego reliance on human intervention in certain situations such as Level 4 ADS-operated vehicles), conditional autonomous vehicles (e.g., vehicles that forego reliance on human intervention in limited situations such as Level 3 ADS-operated vehicles) and/or the like. In one embodiment, autonomous system 202 includes operational or tactical functionality required to operate vehicle 200 in on-road traffic and perform part or all of Dynamic Driving Task (DDT) on a sustained basis. In another embodiment, autonomous system 202 includes an Advanced Driver Assistance System (ADAS) that includes driver support features. Autonomous system 202 supports various levels of driving automation, ranging from no driving automation (e.g., Level 0) to full driving automation (e.g., Level 5). For a detailed description of fully autonomous vehicles and highly autonomous vehicles, reference may be made to SAE International's standard J3016: Taxonomy and Definitions for Terms Related to On-Road Motor Vehicle Automated Driving Systems, which is incorporated by reference in its entirety. In some embodiments, vehicle 200 is associated with an autonomous fleet manager and/or a ridesharing company.

Autonomous system 202 includes a sensor suite that includes one or more devices such as cameras 202a, LiDAR sensors 202b, radar sensors 202c, and microphones 202d. In some embodiments, autonomous system 202 can include more or fewer devices and/or different devices (e.g., ultrasonic sensors, inertial sensors, GPS receivers (discussed below), odometry sensors that generate data associated with an indication of a distance that vehicle 200 has traveled, and/or the like). In some embodiments, autonomous system 202 uses the one or more devices included in autonomous system 202 to generate data associated with environment 100, described herein. The data generated by the one or more devices of autonomous system 202 can be used by one or more systems described herein to observe the environment (e.g., environment 100) in which vehicle 200 is located. In some embodiments, autonomous system 202 includes communication device 202e, autonomous vehicle compute 202f, drive-by-wire (DBW) system 202h, and safety controller 202g.

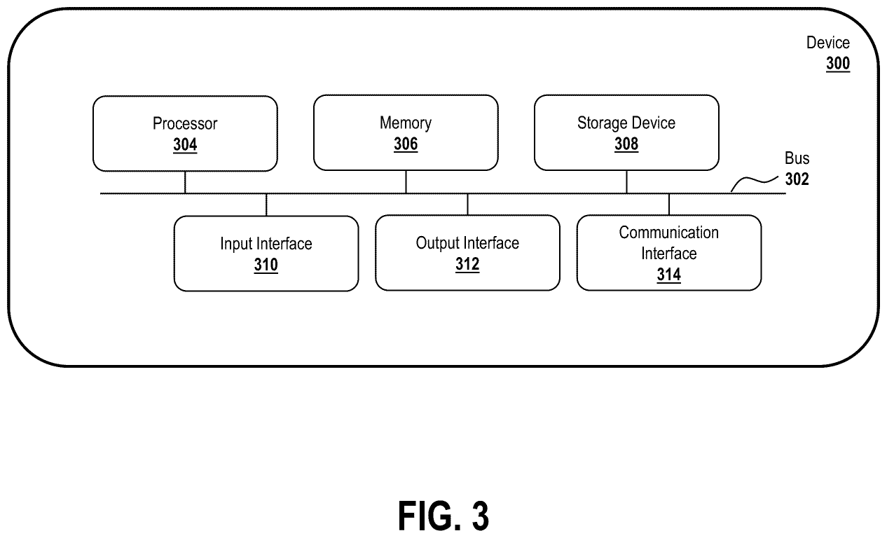

Cameras 202a include at least one device configured to be in communication with communication device 202e, autonomous vehicle compute 202f, and/or safety controller 202g via a bus (e.g., a bus that is the same as or similar to bus 302 of FIG. 3). Cameras 202a include at least one camera (e.g., a digital camera using a light sensor such as a Charge-Coupled Device (CCD), a thermal camera, an infrared (IR) camera, an event camera, and/or the like) to capture images including physical objects (e.g., cars, buses, curbs, people, and/or the like). In some embodiments, camera 202a generates camera data as output. In some examples, camera 202a generates camera data that includes image data associated with an image. In this example, the image data may specify at least one parameter (e.g., image characteristics such as exposure, brightness, etc., an image timestamp, and/or the like) corresponding to the image. In such an example, the image may be in a format (e.g., RAW, JPEG, PNG, and/or the like). In some embodiments, camera 202a includes a plurality of independent cameras configured on (e.g., positioned on) a vehicle to capture images for the purpose of stereopsis (stereo vision). In some examples, camera 202a includes a plurality of cameras that generate image data and transmit the image data to autonomous vehicle compute 202f and/or a fleet management system (e.g., a fleet management system that is the same as or similar to fleet management system 116 of FIG. 1). In such an example, autonomous vehicle compute 202f determines depth to one or more objects in a field of view of at least two cameras of the plurality of cameras based on the image data from the at least two cameras. In some embodiments, cameras 202a is configured to capture images of objects within a distance from cameras 202a (e.g., up to 100 meters, up to a kilometer, and/or the like). Accordingly, cameras 202a include features such as sensors and lenses that are optimized for perceiving objects that are at one or more distances from cameras 202a.

In an embodiment, camera 202a includes at least one camera configured to capture one or more images associated with one or more traffic lights, street signs and/or other physical objects that provide visual navigation information. In some embodiments, camera 202a generates traffic light data associated with one or more images. In some examples, camera 202a generates TLD (Traffic Light Detection) data associated with one or more images that include a format (e.g., RAW, JPEG, PNG, and/or the like). In some embodiments, camera 202a that generates TLD data differs from other systems described herein incorporating cameras in that camera 202a can include one or more cameras with a wide field of view (e.g., a wide-angle lens, a fish-eye lens, a lens having a viewing angle of approximately 120 degrees or more, and/or the like) to generate images about as many physical objects as possible.

Light Detection and Ranging (LiDAR) sensors 202b include at least one device configured to be in communication with communication device 202e, autonomous vehicle compute 202f, and/or safety controller 202g via a bus (e.g., a bus that is the same as or similar to bus 302 of FIG. 3). LiDAR sensors 202b include a system configured to transmit light from a light emitter (e.g., a laser transmitter). Light emitted by LiDAR sensors 202b include light (e.g., infrared light and/or the like) that is outside of the visible spectrum. In some embodiments, during operation, light emitted by LiDAR sensors 202b encounters a physical object (e.g., a vehicle) and is reflected back to LiDAR sensors 202b. In some embodiments, the light emitted by LiDAR sensors 202b does not penetrate the physical objects that the light encounters. LiDAR sensors 202b also include at least one light detector which detects the light that was emitted from the light emitter after the light encounters a physical object. In some embodiments, at least one data processing system associated with LiDAR sensors 202b generates an image (e.g., a point cloud, a combined point cloud, and/or the like) representing the objects included in a field of view of LiDAR sensors 202b. In some examples, the at least one data processing system associated with LiDAR sensor 202b generates an image that represents the boundaries of a physical object, the surfaces (e.g., the topology of the surfaces) of the physical object, and/or the like. In such an example, the image is used to determine the boundaries of physical objects in the field of view of LiDAR sensors 202b.

Radio Detection and Ranging (radar) sensors 202c include at least one device configured to be in communication with communication device 202e, autonomous vehicle compute 202f, and/or safety controller 202g via a bus (e.g., a bus that is the same as or similar to bus 302 of FIG. 3). Radar sensors 202c include a system configured to transmit radio waves (either pulsed or continuously). The radio waves transmitted by radar sensors 202c include radio waves that are within a predetermined spectrum. In some embodiments, during operation, radio waves transmitted by radar sensors 202c encounter a physical object and are reflected back to radar sensors 202c. In some embodiments, the radio waves transmitted by radar sensors 202c are not reflected by some objects. In some embodiments, at least one data processing system associated with radar sensors 202c generates signals representing the objects included in a field of view of radar sensors 202c. For example, the at least one data processing system associated with radar sensor 202c generates an image that represents the boundaries of a physical object, the surfaces (e.g., the topology of the surfaces) of the physical object, and/or the like. In some examples, the image is used to determine the boundaries of physical objects in the field of view of radar sensors 202c.

Microphones 202d includes at least one device configured to be in communication with communication device 202e, autonomous vehicle compute 202f, and/or safety controller 202g via a bus (e.g., a bus that is the same as or similar to bus 302 of FIG. 3). Microphones 202d include one or more microphones (e.g., array microphones, external microphones, and/or the like) that capture audio signals and generate data associated with (e.g., representing) the audio signals. In some examples, microphones 202d include transducer devices and/or like devices. In some embodiments, one or more systems described herein can receive the data generated by microphones 202d and determine a position of an object relative to vehicle 200 (e.g., a distance and/or the like) based on the audio signals associated with the data.

Communication device 202e includes at least one device configured to be in communication with cameras 202a, LiDAR sensors 202b, radar sensors 202c, microphones 202d, autonomous vehicle compute 202f, safety controller 202g, and/or DBW (Drive-By-Wire) system 202h. For example, communication device 202e may include a device that is the same as or similar to communication interface 314 of FIG. 3. In some embodiments, communication device 202e includes a vehicle-to-vehicle (V2V) communication device (e.g., a device that enables wireless communication of data between vehicles).

Autonomous vehicle compute 202f include at least one device configured to be in communication with cameras 202a, LiDAR sensors 202b, radar sensors 202c, microphones 202d, communication device 202e, safety controller 202g, and/or DBW system 202h. In some examples, autonomous vehicle compute 202f includes a device such as a client device, a mobile device (e.g., a cellular telephone, a tablet, and/or the like), a server (e.g., a computing device including one or more central processing units, graphical processing units, and/or the like), and/or the like. In some embodiments, autonomous vehicle compute 202f is the same as or similar to autonomous vehicle compute 400, described herein. Additionally, or alternatively, in some embodiments autonomous vehicle compute 202f is configured to be in communication with an autonomous vehicle system (e.g., an autonomous vehicle system that is the same as or similar to remote AV system 114 of FIG. 1), a fleet management system (e.g., a fleet management system that is the same as or similar to fleet management system 116 of FIG. 1), a V2I device (e.g., a V2I device that is the same as or similar to V2I device 110 of FIG. 1), and/or a V2I system (e.g., a V2I system that is the same as or similar to V2I system 118 of FIG. 1).

Safety controller 202g includes at least one device configured to be in communication with cameras 202a, LiDAR sensors 202b, radar sensors 202c, microphones 202d, communication device 202e, autonomous vehicle computer 202f, and/or DBW system 202h. In some examples, safety controller 202g includes one or more controllers (electrical controllers, electromechanical controllers, and/or the like) that are configured to generate and/or transmit control signals to operate one or more devices of vehicle 200 (e.g., powertrain control system 204, steering control system 206, brake system 208, and/or the like). In some embodiments, safety controller 202g is configured to generate control signals that take precedence over (e.g., overrides) control signals generated and/or transmitted by autonomous vehicle compute 202f.

DBW system 202h includes at least one device configured to be in communication with communication device 202e and/or autonomous vehicle compute 202f. In some examples, DBW system 202h includes one or more controllers (e.g., electrical controllers, electromechanical controllers, and/or the like) that are configured to generate and/or transmit control signals to operate one or more devices of vehicle 200 (e.g., powertrain control system 204, steering control system 206, brake system 208, and/or the like). Additionally, or alternatively, the one or more controllers of DBW system 202h are configured to generate and/or transmit control signals to operate at least one different device (e.g., a turn signal, headlights, door locks, windshield wipers, and/or the like) of vehicle 200.

Powertrain control system 204 includes at least one device configured to be in communication with DBW system 202h. In some examples, powertrain control system 204 includes at least one controller, actuator, and/or the like. In some embodiments, powertrain control system 204 receives control signals from DBW system 202h and powertrain control system 204 causes vehicle 200 to make longitudinal vehicle motion, such as start moving forward, stop moving forward, start moving backward, stop moving backward, accelerate in a direction, decelerate in a direction or to make lateral vehicle motion such as performing a left turn, performing a right turn, and/or the like. In an example, powertrain control system 204 causes the energy (e.g., fuel, electricity, and/or the like) provided to a motor of the vehicle to increase, remain the same, or decrease, thereby causing at least one wheel of vehicle 200 to rotate or not rotate.

Steering control system 206 includes at least one device configured to rotate one or more wheels of vehicle 200. In some examples, steering control system 206 includes at least one controller, actuator, and/or the like. In some embodiments, steering control system 206 causes the front two wheels and/or the rear two wheels of vehicle 200 to rotate to the left or right to cause vehicle 200 to turn to the left or right. In other words, steering control system 206 causes activities necessary for the regulation of the y-axis component of vehicle motion.

Brake system 208 includes at least one device configured to actuate one or more brakes to cause vehicle 200 to reduce speed and/or remain stationary. In some examples, brake system 208 includes at least one controller and/or actuator that is configured to cause one or more calipers associated with one or more wheels of vehicle 200 to close on a corresponding rotor of vehicle 200. Additionally, or alternatively, in some examples brake system 208 includes an automatic emergency braking (AEB) system, a regenerative braking system, and/or the like.

In some embodiments, vehicle 200 includes at least one platform sensor (not explicitly illustrated) that measures or infers properties of a state or a condition of vehicle 200. In some examples, vehicle 200 includes platform sensors such as a global positioning system (GPS) receiver, an inertial measurement unit (IMU), a wheel speed sensor, a wheel brake pressure sensor, a wheel torque sensor, an engine torque sensor, a steering angle sensor, and/or the like. Although brake system 208 is illustrated to be located in the near side of vehicle 200 in FIG. 2, brake system 208 may be located anywhere in vehicle 200.

Referring now to FIG. 3, illustrated is a schematic diagram of a device 300. As illustrated, device 300 includes processor 304, memory 306, storage component 308, input interface 310, output interface 312, communication interface 314, and bus 302. In some embodiments, device 300 corresponds to at least one device of vehicles 102 (e.g., at least one device of a system of vehicles 102), at least one device of vehicle 200 of FIG. 2, and/or one or more devices of network 112 (e.g., one or more devices of a system of network 112). In some embodiments, one or more devices of vehicles 102 (e.g., one or more devices of a system of vehicles 102), and/or one or more devices of network 112 (e.g., one or more devices of a system of network 112) include at least one device 300 and/or at least one component of device 300. As shown in FIG. 3, device 300 includes bus 302, processor 304, memory 306, storage component 308, input interface 310, output interface 312, and communication interface 314.

Bus 302 includes a component that permits communication among the components of device 300. In some cases, the processor 304 includes a processor (e.g., a central processing unit (CPU), a graphics processing unit (GPU), an accelerated processing unit (APU), and/or the like), a microphone, a digital signal processor (DSP), and/or any processing component (e.g., a field-programmable gate array (FPGA), an application specific integrated circuit (ASIC), and/or the like) that can be programmed to perform at least one function. Memory 306 includes random access memory (RAM), read-only memory (ROM), and/or another type of dynamic and/or static storage device (e.g., flash memory, magnetic memory, optical memory, and/or the like) that stores data and/or instructions for use by processor 304.

Storage component 308 stores data and/or software related to the operation and use of device 300. In some examples, storage component 308 includes a hard disk (e.g., a magnetic disk, an optical disk, a magneto-optic disk, a solid state disk, and/or the like), a compact disc (CD), a digital versatile disc (DVD), a floppy disk, a cartridge, a magnetic tape, a CD-ROM, RAM, PROM, EPROM, FLASH-EPROM, NV-RAM, and/or another type of computer readable medium, along with a corresponding drive.

Input interface 310 includes a component that permits device 300 to receive information, such as via user input (e.g., a touchscreen display, a keyboard, a keypad, a mouse, a button, a switch, a microphone, a camera, and/or the like). Additionally or alternatively, in some embodiments input interface 310 includes a sensor that senses information (e.g., a global positioning system (GPS) receiver, an accelerometer, a gyroscope, an actuator, and/or the like). Output interface 312 includes a component that provides output information from device 300 (e.g., a display, a speaker, one or more light-emitting diodes (LEDs), and/or the like).

In some embodiments, communication interface 314 includes a transceiver-like component (e.g., a transceiver, a separate receiver and transmitter, and/or the like) that permits device 300 to communicate with other devices via a wired connection, a wireless connection, or a combination of wired and wireless connections. In some examples, communication interface 314 permits device 300 to receive information from another device and/or provide information to another device. In some examples, communication interface 314 includes an Ethernet interface, an optical interface, a coaxial interface, an infrared interface, a radio frequency (RF) interface, a universal serial bus (USB) interface, a WiFi® interface, a cellular network interface, and/or the like.

In some embodiments, device 300 performs one or more processes described herein. Device 300 performs these processes based on processor 304 executing software instructions stored by a computer-readable medium, such as memory 306 and/or storage component 308. A computer-readable medium (e.g., a non-transitory computer readable medium) is defined herein as a non-transitory memory device. A non-transitory memory device includes memory space located inside a single physical storage device or memory space spread across multiple physical storage devices.

In some embodiments, software instructions are read into memory 306 and/or storage component 308 from another computer-readable medium or from another device via communication interface 314. When executed, software instructions stored in memory 306 and/or storage component 308 cause processor 304 to perform one or more processes described herein. Additionally or alternatively, hardwired circuitry is used in place of or in combination with software instructions to perform one or more processes described herein. Thus, embodiments described herein are not limited to any specific combination of hardware circuitry and software unless explicitly stated otherwise.

Memory 306 and/or storage component 308 includes data storage or at least one data structure (e.g., a database and/or the like). Device 300 is capable of receiving information from, storing information in, communicating information to, or searching information stored in the data storage or the at least one data structure in memory 306 or storage component 308. In some examples, the information includes network data, input data, output data, or any combination thereof.

In some embodiments, device 300 is configured to execute software instructions that are either stored in memory 306 and/or in the memory of another device (e.g., another device that is the same as or similar to device 300). As used herein, the term “module” refers to at least one instruction stored in memory 306 and/or in the memory of another device that, when executed by processor 304 and/or by a processor of another device (e.g., another device that is the same as or similar to device 300) cause device 300 (e.g., at least one component of device 300) to perform one or more processes described herein. In some embodiments, a module is implemented in software, firmware, hardware, and/or the like.

The number and arrangement of components illustrated in FIG. 3 are provided as an example. In some embodiments, device 300 can include additional components, fewer components, different components, or differently arranged components than those illustrated in FIG. 3. Additionally or alternatively, a set of components (e.g., one or more components) of device 300 can perform one or more functions described as being performed by another component or another set of components of device 300.

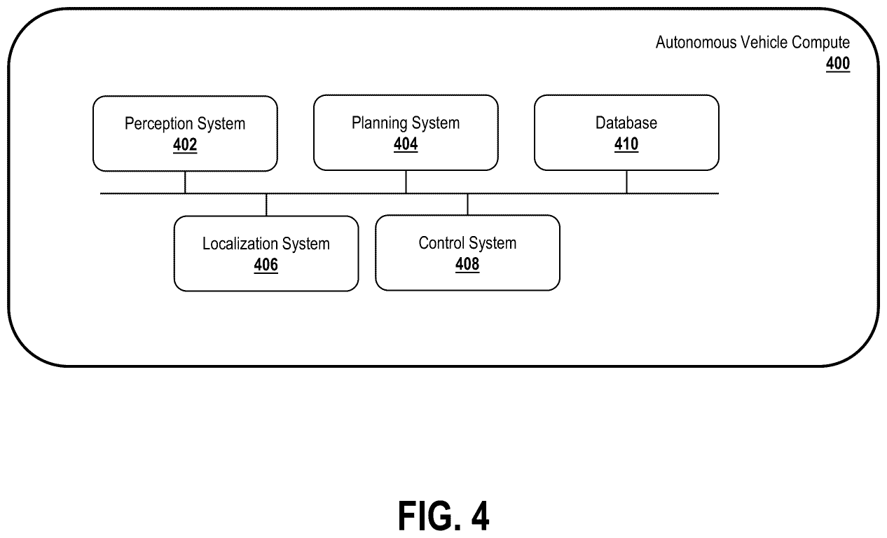

Referring now to FIG. 4, illustrated is an example block diagram of an autonomous vehicle compute 400 (sometimes referred to as an “AV stack”). As illustrated, autonomous vehicle compute 400 includes perception system 402 (sometimes referred to as a perception module), planning system 404 (sometimes referred to as a planning module), localization system 406 (sometimes referred to as a localization module), control system 408 (sometimes referred to as a control module), and database 410. In some embodiments, perception system 402, planning system 404, localization system 406, control system 408, and database 410 are included and/or implemented in an autonomous navigation system of a vehicle (e.g., autonomous vehicle compute 202f of vehicle 200). Additionally, or alternatively, in some embodiments perception system 402, planning system 404, localization system 406, control system 408, and database 410 are included in one or more standalone systems (e.g., one or more systems that are the same as or similar to autonomous vehicle compute 400 and/or the like). In some examples, perception system 402, planning system 404, localization system 406, control system 408, and database 410 are included in one or more standalone systems that are located in a vehicle and/or at least one remote system as described herein. In some embodiments, any and/or all of the systems included in autonomous vehicle compute 400 are implemented in software (e.g., in software instructions stored in memory), computer hardware (e.g., by microprocessors, microcontrollers, application-specific integrated circuits (ASICs), Field Programmable Gate Arrays (FPGAs), and/or the like), or combinations of computer software and computer hardware. It will also be understood that, in some embodiments, autonomous vehicle compute 400 is configured to be in communication with a remote system (e.g., an autonomous vehicle system that is the same as or similar to remote AV system 114, a fleet management system 116 that is the same as or similar to fleet management system 116, a V2I system that is the same as or similar to V2I system 118, and/or the like).

In some embodiments, perception system 402 receives data associated with at least one physical object (e.g., data that is used by perception system 402 to detect the at least one physical object) in an environment and classifies the at least one physical object. In some examples, perception system 402 receives image data captured by at least one camera (e.g., cameras 202a), the image associated with (e.g., representing) one or more physical objects within a field of view of the at least one camera. In such an example, perception system 402 classifies at least one physical object based on one or more groupings of physical objects (e.g., bicycles, vehicles, traffic signs, pedestrians, and/or the like). In some embodiments, perception system 402 transmits data associated with the classification of the physical objects to planning system 404 based on perception system 402 classifying the physical objects.

In some embodiments, planning system 404 receives data associated with a destination and generates data associated with at least one route (e.g., routes 106) along which a vehicle (e.g., vehicles 102) can travel along toward a destination. In some embodiments, planning system 404 periodically or continuously receives data from perception system 402 (e.g., data associated with the classification of physical objects, described above) and planning system 404 updates the at least one trajectory or generates at least one different trajectory based on the data generated by perception system 402. In other words, planning system 404 may perform tactical function-related tasks that are required to operate vehicle 102 in on-road traffic. Tactical efforts involve maneuvering the vehicle in traffic during a trip, including but not limited to deciding whether and when to overtake another vehicle, change lanes, or selecting an appropriate speed, acceleration, deacceleration, etc. In some embodiments, planning system 404 receives data associated with an updated position of a vehicle (e.g., vehicles 102) from localization system 406 and planning system 404 updates the at least one trajectory or generates at least one different trajectory based on the data generated by localization system 406.

In some embodiments, localization system 406 receives data associated with (e.g., representing) a location of a vehicle (e.g., vehicles 102) in an area. In some examples, localization system 406 receives LiDAR data associated with at least one point cloud generated by at least one LiDAR sensor (e.g., LiDAR sensors 202b). In certain examples, localization system 406 receives data associated with at least one point cloud from multiple LiDAR sensors and localization system 406 generates a combined point cloud based on each of the point clouds. In these examples, localization system 406 compares the at least one point cloud or the combined point cloud to two-dimensional (2D) and/or a three-dimensional (3D) map of the area stored in database 410. Localization system 406 then determines the position of the vehicle in the area based on localization system 406 comparing the at least one point cloud or the combined point cloud to the map. In some embodiments, the map includes a combined point cloud of the area generated prior to navigation of the vehicle. In some embodiments, maps include, without limitation, high-precision maps of the roadway geometric properties, maps describing road network connectivity properties, maps describing roadway physical properties (such as traffic speed, traffic volume, the number of vehicular and cyclist traffic lanes, lane width, lane traffic directions, or lane marker types and locations, or combinations thereof), and maps describing the spatial locations of road features such as crosswalks, traffic signs or other travel signals of various types. In some embodiments, the map is generated in real-time based on the data received by the perception system.

In another example, localization system 406 receives Global Navigation Satellite System (GNSS) data generated by a global positioning system (GPS) receiver. In some examples, localization system 406 receives GNSS data associated with the location of the vehicle in the area and localization system 406 determines a latitude and longitude of the vehicle in the area. In such an example, localization system 406 determines the position of the vehicle in the area based on the latitude and longitude of the vehicle. In some embodiments, localization system 406 generates data associated with the position of the vehicle. In some examples, localization system 406 generates data associated with the position of the vehicle based on localization system 406 determining the position of the vehicle. In such an example, the data associated with the position of the vehicle includes data associated with one or more semantic properties corresponding to the position of the vehicle.

In some embodiments, control system 408 receives data associated with at least one trajectory from planning system 404 and control system 408 controls operation of the vehicle. In some examples, control system 408 receives data associated with at least one trajectory from planning system 404 and control system 408 controls operation of the vehicle by generating and transmitting control signals to cause a powertrain control system (e.g., DBW system 202h, powertrain control system 204, and/or the like), a steering control system (e.g., steering control system 206), and/or a brake system (e.g., brake system 208) to operate. For example, control system 408 is configured to perform operational functions such as a lateral vehicle motion control or a longitudinal vehicle motion control. The lateral vehicle motion control causes activities necessary for the regulation of the y-axis component of vehicle motion. The longitudinal vehicle motion control causes activities necessary for the regulation of the x-axis component of vehicle motion. In an example, where a trajectory includes a left turn, control system 408 transmits a control signal to cause steering control system 206 to adjust a steering angle of vehicle 200, thereby causing vehicle 200 to turn left. Additionally, or alternatively, control system 408 generates and transmits control signals to cause other devices (e.g., headlights, turn signal, door locks, windshield wipers, and/or the like) of vehicle 200 to change states.

In some embodiments, perception system 402, planning system 404, localization system 406, and/or control system 408 implement at least one machine learning model (e.g., at least one multilayer perceptron (MLP), at least one convolutional neural network (CNN), at least one recurrent neural network (RNN), at least one autoencoder, at least one transformer, and/or the like). In some examples, perception system 402, planning system 404, localization system 406, and/or control system 408 implement at least one machine learning model alone or in combination with one or more of the above-noted systems. In some examples, perception system 402, planning system 404, localization system 406, and/or control system 408 implement at least one machine learning model as part of a pipeline (e.g., a pipeline for identifying one or more objects located in an environment and/or the like).

Database 410 stores data that is transmitted to, received from, and/or updated by perception system 402, planning system 404, localization system 406 and/or control system 408. In some examples, database 410 includes a storage component (e.g., a storage component that is the same as or similar to storage component 308 of FIG. 3) that stores data and/or software related to the operation and uses at least one system of autonomous vehicle compute 400. In some embodiments, database 410 stores data associated with 2D and/or 3D maps of at least one area. In some examples, database 410 stores data associated with 2D and/or 3D maps of a portion of a city, multiple portions of multiple cities, multiple cities, a county, a state, a State (e.g., a country), and/or the like). In such an example, a vehicle (e.g., a vehicle that is the same as or similar to vehicles 102 and/or vehicle 200) can drive along one or more drivable regions (e.g., single-lane roads, multi-lane roads, highways, back roads, off road trails, and/or the like) and cause at least one LiDAR sensor (e.g., a LiDAR sensor that is the same as or similar to LiDAR sensors 202b) to generate data associated with an image representing the objects included in a field of view of the at least one LiDAR sensor.

In some embodiments, database 410 can be implemented across a plurality of devices. In some examples, database 410 is included in a vehicle (e.g., a vehicle that is the same as or similar to vehicles 102 and/or vehicle 200), an autonomous vehicle system (e.g., an autonomous vehicle system that is the same as or similar to remote AV system 114, a fleet management system (e.g., a fleet management system that is the same as or similar to fleet management system 116 of FIG. 1, a V2I system (e.g., a V2I system that is the same as or similar to V2I system 118 of FIG. 1) and/or the like.

Camera Cleaning and Flare Reduction

Autonomous or self-driving vehicles often include one or more image sensors or cameras (as well as other types of sensors) for detecting objects within the environment of the vehicles. Such image sensors or cameras can also be included on traditional vehicles (e.g., non-autonomous or non-self-driving vehicles). Vehicles including cameras or other image sensors may rely on processing images received from the cameras or image sensors to facilitate driving of the vehicle. Accordingly, it can be important that the images sensors and cameras capture images that are sufficiently clear and high quality.

During operation of the vehicles, however, the vehicle cameras are exposed to the environment and can become dirty, leading to lower quality images. In particular, a lens of the camera can be impacted or otherwise affected by dirt, dust, rain, stones, exhaust, insects, or the like.

As described herein, a camera or other image sensor can be protected by positioning the camera within a housing. The housing can include at least one transparent window through which the camera captures images. In some embodiments, the environment within the housing can be regulated. For example, the temperature, humidity, or other characteristics of the air within the housing can be regulated. In this way, it can be possible to regulate the environment in which the camera operates.

In some embodiments, the housing may include one or more cleaning devices that are operable to clean the transparent window of the housing, thus providing a clean window through which the camera can capture images. In some embodiments, the cleaning device can include a wiper that is actuated to clean the window. In some embodiments, the cleaning device can include a nozzle configured to direct a jet of air, water, or other gases of fluids onto the transparent window to clean the window. Other cleaning devices are also possible. In some instances, actuation of the cleaning device can by triggered based on an analysis of an image captured by the camera through the transparent window.

In some embodiments, the housing can include one or more optical panels that can be selectively moved in front of the lens of the camera. The optical panels can be configured with different optical properties to provide various functionality. For example, in some embodiments, the optical panels can include clear, tinted, anti-glare, or photochromatic-adapted glass or plastic panels, or the like. The optical panels can be moved in front of the lens of the camera to adjust the image captured by the camera. In some instances, selection and movement of the optical panels in front of the lens of the camera can by triggered based on an analysis of an image captured by the camera. For example, the image can be analyzed to determine the presence of a flare within the image. Upon detecting a flare, an appropriate optical panel can be moved in front of the lens of the camera. In some embodiments, the movement of the optical panels can be triggered manually.

By virtue of the implementation of systems, methods, and computer program products described herein, techniques for camera cleaning and flare reduction and protection for cameras of vehicles various advantages can be achieved. For example, the image quality of images captured by the cameras can be improved and or maintained at a sufficient quality level. The images captured by the cameras are generally analyzed to determine the presence of objects in the environment of the car, such as pedestrians, street signs, other vehicles, and the like. Thus, it can be quite important that the quality of the images is maintained as high as possible to ensure safe operation of the vehicle. These considerations can be especially important for self-driving and autonomous vehicles to ensure safe operation.

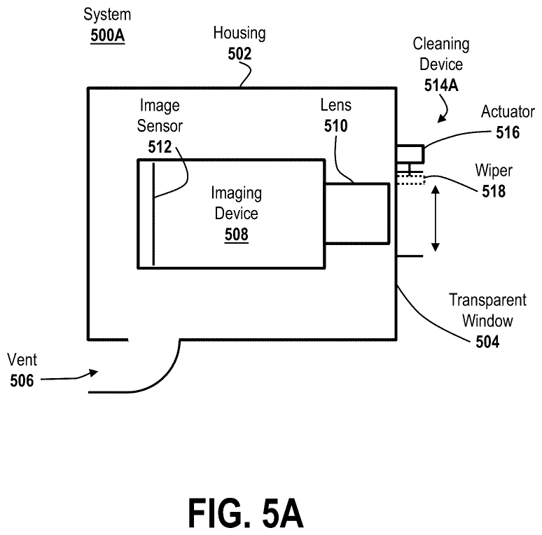

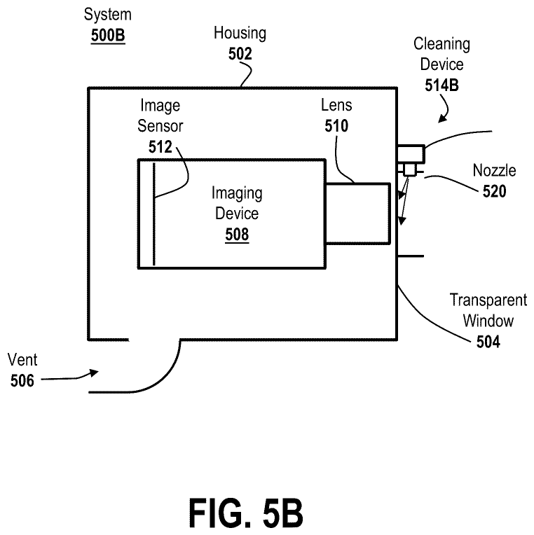

FIG. 5A illustrates an embodiment of a system 500A comprising an imaging device 508 and a cleaning device 514A. The cleaning device 514A can be configured to clean a transparent window 504 of a housing 502 in which the imaging device 508 is positioned.

In the illustrated embodiment, the system 500A includes the housing 502. The housing 502 can be an enclosure, box, or other structure that partially or completely surrounds the imaging device 508. The imaging device 508 can be positioned within the housing 502 such that the housing 502 provides one or more barriers between the imaging device 508 and the environment outside of the housing 502.

In some embodiments, the imaging device 508 is attached to an interior portion of the housing 502. In some embodiments, the housing 502 tightly surrounds the imaging device 508 such that little to no space exists between the imaging device 502 and the interior walls of the housing 502. In other embodiments, the housing 502 may be larger than the imaging device 508 such that space surrounds the imaging device 508 within the housing. For example, in some embodiments, there can be 0.5 cm, 1 cm, 2 cm, 3 cm or more of clearance between the imaging device 508 and the interior walls of the housing 502.

As shown in the illustrated embodiment of FIG. 5A, for some embodiments, a vent 506 can be connected to the housing 502. The vent 502 can be configured to direct environmentally regulated air into the housing 502. The environmentally regulated air can be configured to provide an optimal or improved operating condition for the imaging device 508. For example, in some embodiments, the vent 502 directs temperature-controlled and/or humidity-controlled air into the interior of the housing 502. This can, for example, be useful to prevent the imaging device 508 from overheating.

In some embodiments, the vent 506 is configured to direct air from within a passenger compartment of the vehicle into the interior of the housing. In some embodiments, the vent 506 can be connected to a separate environmental regulating control system that supplies the environmentally regulated air.

The imaging device 508 may comprise, for example, one or more lenses 510 or lens assemblies that are configured to direct (e.g., focus light) onto an image sensor 512 to produce an image or images. In some embodiments, the imaging device 508 comprises a camera. For example, imaging device 508 can include at least one camera (e.g., a digital camera using a light sensor such as a Charge-Coupled Device (CCD), a thermal camera, an infrared (IR) camera, an event camera, and/or the like) to capture images including physical objects (e.g., cars, buses, curbs, people, and/or the like). In some embodiments, imaging device 508 (e.g., the image sensor 512 thereof) generates camera data as output. In some examples, imaging device 508 generates camera data that includes image data associated with an image. In this example, the image data may specify at least one parameter (e.g., image characteristics such as exposure, brightness, etc., an image timestamp, and/or the like) corresponding to the image. In such an example, the image may be in a format (e.g., RAW, J PEG, PNG, and/or the like). In some embodiments, imaging device 508 includes a plurality of independent cameras configured to capture images for the purpose of stereopsis (stereo vision).

In some examples, imaging device 508 includes a plurality of cameras that generate image data and transmit the image data to autonomous vehicle compute 202f (see FIG. 2) and/or a fleet management system (e.g., a fleet management system that is the same as or similar to fleet management system 116 of FIG. 1). In some such examples, autonomous vehicle compute 202f can determine depth to one or more objects in a field of view of at least two cameras of the plurality of cameras based on the image data from the at least two cameras. In some embodiments, imaging device 508 is configured to capture images of objects within a distance from the imaging device 508 (e.g., up to 100 meters, up to a kilometer, and/or the like). Accordingly, imaging device 508 can include features such as sensors 512 and lenses 510 that are optimized for perceiving objects that are at one or more distances from the imaging device 508.

In an embodiment, imaging device 508 includes at least one camera configured to capture one or more images associated with one or more traffic lights, street signs and/or other physical objects that provide visual navigation information. In some embodiments, imaging device 508 generates traffic light data associated with one or more images. In some examples, imaging device 508 generates TLD (Traffic Light Detection) data associated with one or more images that include a format (e.g., RAW, JPEG, PNG, and/or the like). In some embodiments, imaging device 508 that generates TLD data differs from other systems described herein incorporating cameras in that imaging device 508 can include one or more cameras with a wide field of view (e.g., a wide-angle lens, a fish-eye lens, a lens having a viewing angle of approximately 120 degrees or more, and/or the like) to generate images about as many physical objects as possible. In some embodiments, the imaging device 508 is configured to capture one or more images in order to detect various objects in the environment of vehicle, such as other vehicles, pedestrians, bicycles, etc.

The imaging device 508 is oriented within the housing 502 such that the imaging device 508 is configured to capture images through a transparent window 504 included on the housing 502. The transparent window 504 can comprise, for example, a glass or plastic transparent or clear panel. The transparent window 504 can be positioned in front of the lens 510 of the imaging device such that light gathered by the lens 510 first passes through the transparent window 504.

As described above, the housing 502 protects the imaging device 508 from the environment. Accordingly, the exterior or a portion of the exterior of the housing 502 may be exposed to the environment. The transparent window 504 may be exposed to the environment and thus may be susceptible to becoming dirty. For example, the system 500A can be included on a vehicle. During operation of the vehicle, the transparent window 504 of the housing 502 can be exposed to things like dirt, dust, exhaust, rain, stones, insects, or the like. Over time, these things can cause the transparent window 504 to become dirty. While the transparent window 504 may become dirty, the imaging device 508 is protected from becoming dirty by the housing 502 and the transparent window. Still, because the imaging device 508 captures images through the transparent window 504, when the transparent window becomes dirty, the quality of the images captured by the imaging device 508 can be negatively affected.

Accordingly, and as shown in the embodiment of FIG. 5A, the system 500A can include a window cleaning device 514. The window cleaning device 514 can be configured to clean the transparent window 504. In the illustrated embodiment, the window cleaning device 514 comprises an actuator 516 that is coupled to a wiper 518. The actuator 516 can comprise a motor that is coupled to the wiper 518 to cause movement of the wiper 518. In some embodiments, the actuator 516 is coupled to the wiper 518 through one or more intermediate links, arms, or other structures.

The wiper 518 can be a structure that is configured to clean the exterior surface of the transparent window 504 through contact with the transparent window. For example, in some embodiments, the wiper 518 comprises a scraping implement with an edged blade. In some embodiments, the wiper 518 can comprise a brush. The wiper 518 is configured to clean the transparent window 504 as the wiper is drawn, pushed, or otherwise moved across the surface of the transparent window 504. The actuator 516 can be positioned on or within the housing 502 and configured to drive motion of the wiper 518.

In some embodiments, the cleaning device 514A comprises more than one wiper 518 and/or more than one actuator 516. For example, the cleaning device 514A can comprise, one, two, three, four, or more wipers 518 that are driven by one, two, three, four, or more actuators 516. In some embodiments, the actuators 516 drive the wipers 518 in a back-and-forth or linear motion. In some embodiments, the actuators 516 drive the wipers in a curved or radial motion.

The cleaning device 514A can be actuated to clean the transparent window 504. Triggering the cleaning device 514A can be accomplished in a variety of ways. For example, in one embodiments, the cleaning device 514A is configured to trigger on a periodic basis. For example, the cleaning device 514A can be configured to operate about every 1 minute, about every 5 minutes, about every 15 minutes, about every 30 minutes, about every 1 hour, about every 2 hours, about every 3 hours, about every 4 hours, or at other intervals, both regular and irregular.

In some embodiments, the cleaning device 514A can be triggered on an “as needed” basis. For example, the cleaning device 514 can be operated upon detecting that the transparent window 504 is not sufficiently clean. Detection of the cleanliness of the transparent window 504 can occur in a variety of ways. In one example, images captured by the imaging device 508 can be analyzed (for example, by one or more components of autonomous system 202 of FIG. 2, by one or more components of device 300 of FIG. 3, by one or more components of autonomous vehicle compute 400 of FIG. 4, or by a one or more components of the system 500A itself) to determine the cleanliness state of the transparent window 504. Analysis of the images to determine the cleanliness of the transparent window 504 can include an analysis of the brightness of a captured image, analysis of other image properties, detection of dirt or other items on the transparent window 504, etc.

Images can be analyzed on a continual or periodic basis (e.g., about every 1 second, about every 5 seconds, about every 15 seconds, about every 30 seconds, about every 1 minute, about every 5 minutes, about every 15 minutes, about every 30 minutes, about every 1 hour, about every 2 hours, about every 3 hours, or about every 4, as well as at other intervals both shorter and longer than the listed values) to assess a cleanliness state of the transparent window 504.

In some embodiments, the cleaning device 514A is actuated or triggered upon detecting that a cleanliness state of the transparent window 504 falls below a threshold value. The threshold value can be determined or set so as to improve the likelihood that images captured by the imaging device 508 will be of sufficient quality for processing by the vehicle. In some embodiments, the cleaning 514A can be triggered manually, for example, by an operator or remote operator of the vehicle.

FIG. 5B illustrates another embodiment of a system 500B comprising an imaging device 508 and a cleaning device 514B. The embodiment of system 500B is, in many respects, similar to the embodiment 500A described above with respect to FIG. 5A. However, in the illustrated embodiment of the system 500B, the cleaning device 514B is configured as a nozzle 520. The nozzle 520 can comprise a single nozzle or a plurality of nozzles (e.g., two, three, four, five, or more). The nozzle 520 can be configured to direct air, water, or other gases or fluids, onto the transparent window 504 to clean the window. Accordingly, the nozzle 520 may be connected to a source or pressured gas or fluid. The nozzle 520 may direct a jet of gas or fluid onto the transparent window 504 for cleaning.

In some embodiments, a system may include one or more of the cleaning system 514A of FIG. 5A and one or more of the cleaning system 514B. For example, a system may include both a nozzle 520 configured to direct gas or fluid onto the transparent 514 as well as a wiper 518 configured to clean the transparent window. Further, other window cleaning devices can be, alternatively or additionally, provided.

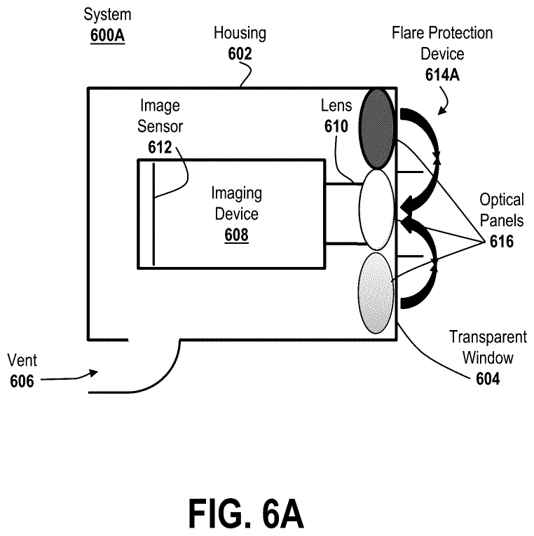

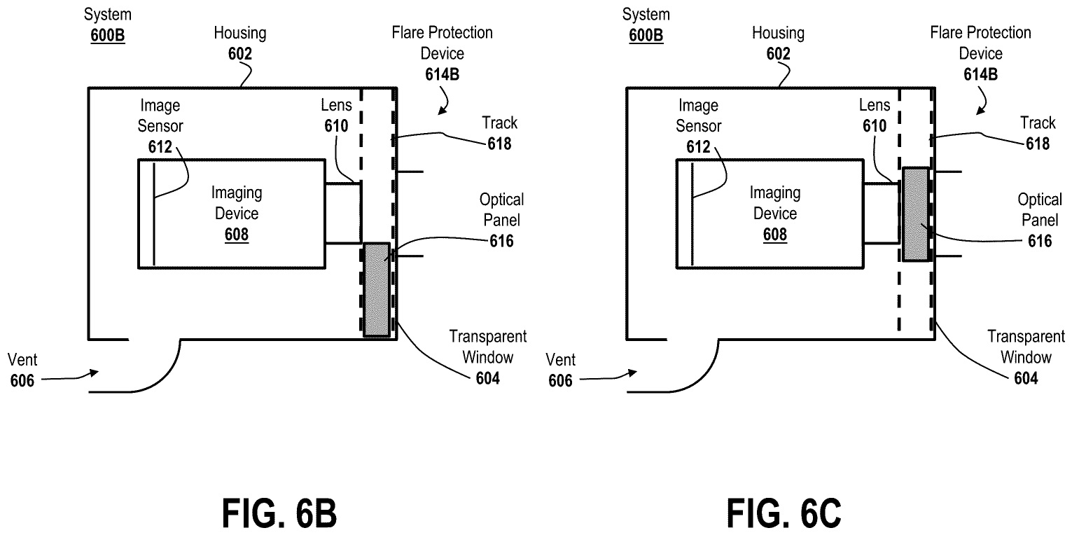

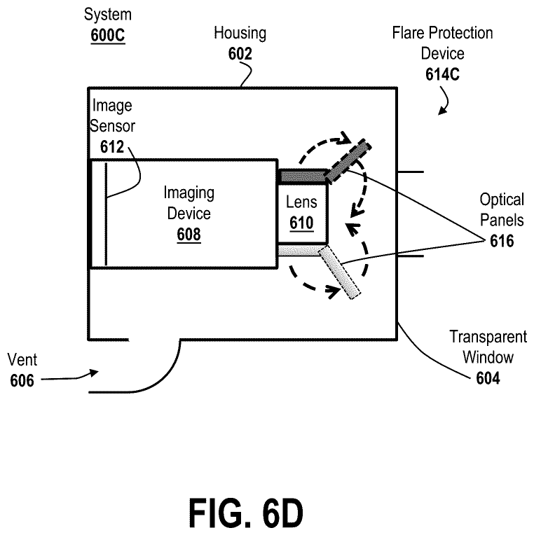

FIG. 6A illustrates an embodiment of a system 600A comprising an imaging device 608 and a flare protection or reduction device 614A. As will be described in more detail below, the flare protection or reduction device 614A can be configured to position different optical panels 616 in front of a lens 610 of an imaging device 608 in order to alter or affect an image captured by the imaging device 608. For example, in some embodiments, the optical panels 616 can be configured or selected to reduce a flare or glare in a captured image.

In the illustrated embodiment, the system 600A includes a housing 602 including a transparent window 604 and a vent 606, which can be substantially similar to the housing 502, the transparent window 504, and the vent with reference to FIG. 5A. Similarly, the imaging device 608, including lens(es) 610 and image sensor(s) 612, can be similar to the imaging device 508 and corresponding components described previously.

As shown in FIG. 6A, the system 600A further includes the flare protection device 614A. In the illustrated embodiment, the flare protection device 614A comprises three optical panels 616, although other numbers of optical panels (e.g. one, two, three, four, five, or more) can be included in other embodiments. The optical panels 616 can be positioned within the housing 602 at a location whereby they can be selectively moved in front of the lens 610 of the imaging device 608 such that images are captured through one or more of the optical panels 616. In some embodiments, the optical panels 616 can be selectively moved to a position between the lens 610 and the transparent window 604.

The optical panels 616 may be transparent such that the camera captures images through the optical panels 616. The optical panels 616 can further be configured with different optical properties to provide various functionality. For example, in some embodiments, the optical panels 616 can comprise clear, tinted, anti-glare, or photochromatic-adapted glass or plastic panels, or the like. Different optical panels 616 can be selectively moved into position in front of the lens 610 to provide a different optical parameter or variation for the imaging device 608. For example, if an image captured by the imaging device 608 includes a flare artifact, an anti-glare panel 616 can be used to reduce the flare. As another example, if the image is too bright, a tinted panel 616 can be used to reduce the brightness.

In some instances, selection and movement of the optical panels 616 in front of the lens of the camera can by triggered based on an analysis of an image captured by the imaging device 608. For example, the image can be analyzed to determine the presence of a flare within the image. Upon detecting a flare, an appropriate optical panel can be moved in front of the lens of the camera.

The analysis can be performed by, for example, one or more components of autonomous system 202 of FIG. 2, by one or more components of device 300 of FIG. 3, by one or more components of autonomous vehicle compute 400 of FIG. 4, or by a one or more components of the system 600A itself. The analysis can include detecting a brightness or saturation of an image, detecting a flare, glare, or other undesirable image artifact within the image, or the like. Images can be analyzed on a continual or periodic basis. In some embodiments, images are analyzed in substantially real time so that different optical panels 616 can be moved into position as needed to produce high quality images.

In some embodiments, the movement of the optical panels 616 can be triggered manually, for example, by an operator or remote operator of the vehicle.

In FIG. 6A, the flare protection or reduction device 614A is configured to rotate optical panels 616 into position in front of the lens 610. For example, a plurality of different optical panels can be positioned on a carrier that can be rotated by an actuator. As the carrier rotates, different optical panels 616 can be moved into position. Other mechanisms or structures for rotating the optical panels 616 into position are also possible. In some embodiments, only a single optical panel 616 can be used. In such cases, a rotation device may not be needed.

FIGS. 6B and 6C illustrate another embodiment of a system 600B comprising an imaging device 608 and a flare protection or reduction device shown 614B shown in first and second states, respectively. The embodiment of system 600B is, in many respects, similar to the embodiment 600A described above with respect to FIG. 6A. However, in the illustrated embodiment of the system 600B, the flare protection or reduction device shown 614B is configured with an optical panel 616 positioned on a track 618. As shown in FIG. 6B, in a first state, the optical panel 616 can be moved to a position that is not in front of the lens 610, and a shown in FIG. 6C, in a second state, the optical panel 616 can be moved to a position that is in front of the lens 610. An actuator, such as a motor or other mechanism, can be used to move the optical panel 616. Although only a single optical panel 616 is illustrated in FIGS. 6B and 6C, in some embodiments other numbers of optical panels 616 can be included (e.g., two, three, four, five, or more). When multiple optical panels 616 are included, these can all be mounted in a single track 618 or within different tracks 618. Further, when multiple optical panels 616 are included, preferably the optical panels 616 are configured with different optical properties.

FIG. 6D illustrates another embodiment of a system 600C comprising an imaging device 610 and a flare protection or reduction device 614C. The embodiment of system 600C is, in many respects, similar to the embodiments 600A, 600B described above with respect to FIGS. 6A-6C. However, in the illustrated embodiment of the system 600C, the flare protection or reduction device shown 614C is configured with optical panels 616 that flip into place in front of the lens 610. For example, as shown, optical panels 616 can be rotated of flipped from a first position located along the side of a lens assembly 610 of the imaging device to a position in front of the lens 610. As before, one or more optical panels 616 can be used.

In some embodiments, a system may include one or more of the flare protection or reduction device 614A of FIG. 6A, one or more of the flare protection or reduction device 614B of FIGS. 6A and 6B, and/or one or more of the flare protection or reduction device 614C of FIG. 6D. Further, other one or more of the flare protection or reduction devices can be, alternatively or additionally, provided. Moreover, the features of the systems 600A, 600B, 600C of FIGS. 6A-6D can be combined with the features of the systems 500A, 500B of FIGS. 5A and 5B. For example, a system can include one or more cleaning devices and one or more flare protection or reduction devices.

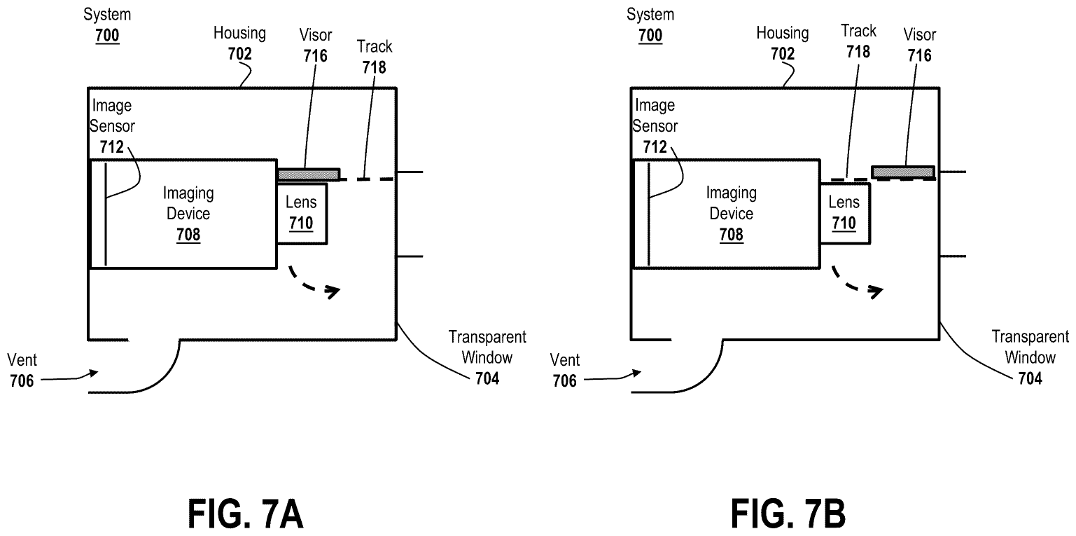

FIGS. 7A and 7B illustrate an embodiment of a system 700 comprising an imaging device 708 and a visor 716 shown in first and second states, respectively. As will be described in more detail below, the visor 716 can be configured to be moved into and out of a position relative to the imaging device 708 to provide shade for the imaging device 708, for example, to block direct strong light.

In the illustrated embodiment, the system 700 includes a housing 702 including a transparent window 704 and a vent 706, which can be substantially similar to the housing 502, the transparent window 504, and the vent with reference to FIG. 5A. Similarly, the imaging device 708, including lens(es) 710 and image sensor(s) 712, can be similar to the imaging device 508 and corresponding components described previously.

As shown in FIGS. 7A and 7B, the system 700 may include a visor 716. The visor 716 can, in some embodiments, comprises an opaque panel configured to block sunlight. In some embodiments, the visor 716 can be semi-opaque or semi-transparent. For example, in some embodiments, the visor may comprise a tinted panel.

In the illustrated embodiment, the visor 716 is positioned in a track 718. An actuator, such as an electric motor, can be provided to drive the visor 716 back and forth within the track. As shown in FIG. 7A, in a first state, the visor 716 is retracted. As shown in FIG. 7B, in a second state, the visor 716 is extended. In the extended state, the visor 716 is positioned relatively in front and above the lens 710 of the imaging device so as to block direct sunlight (or other light) depending on the position of the sun (or other light source).

In some instances, movement of the visor 716 between the two states can by triggered based on an analysis of an image captured by the imaging device 708. For example, the image can be analyzed to determine the presence of a flare (in this case, caused by direct exposure to the sun or other light source) within the image or an overexposure of the image. Upon detecting a flare or over exposure, the visor 716 can be moved into the extended position. The analysis can be performed by, for example, one or more components of autonomous system 202 of FIG. 2, by one or more components of device 300 of FIG. 3, by one or more components of autonomous vehicle compute 400 of FIG. 4, or by a one or more components of the system 700 itself. The analysis can include detecting a brightness or saturation of an image, detecting a flare, glare, or other undesirable image artifact within the image, or the like. Images can be analyzed on a continual or periodic basis. In some embodiments, images are analyzed in substantially real time so that visor 706 can be moved into position as needed to produce high quality images. In some embodiments, the movement of the visor 716 can be triggered manually, for example, by an operator or remote operator of the vehicle

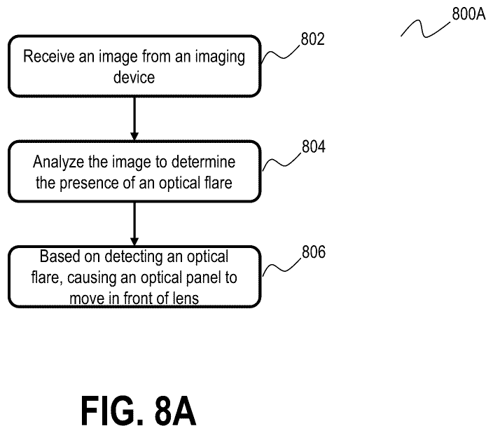

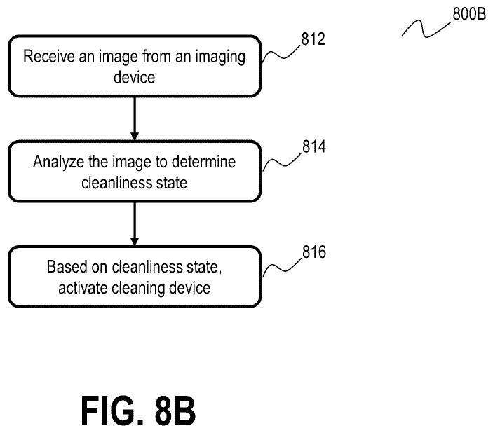

FIG. 8A is a flowchart of a process 800A for flare reduction for an imaging device. The method can be implemented, for example, using the systems 600A, 600B, 600C of FIGS. 6A-6D or the system 700 of FIGS. 7A and 7B, as well as other systems. The process 800A begins at block 802 at which an image is received from an imaging device. At block 804, the image is analyzed to determine the presence (or absence) of an optical flare, glare, or other undesirable image artifact within the image. Based on detecting an optical flare, glare, or other undesirable image artifact within the image, at block 806, an optical panel is moved in front of the lens. The optical panel can be selected to reduce or remove the undesirable image artifact within the image.

FIG. 8B is a flowchart of a process 800B for cleaning an imaging device based on a detected or determined cleanliness state thereof. The method can be implemented, for example, using the systems 500A, 500B of FIGS. 5A and 5B, as well as other systems. The process 800B begins at block 812 at which an image is received from an imaging device. At block 814, the image is analyzed to determine a cleanliness state of a transparent window through which the image was captured. Based on determining that the cleanliness state falls below a threshold, at block 816, a cleaning device is actuated or operated to clean the transparent window.

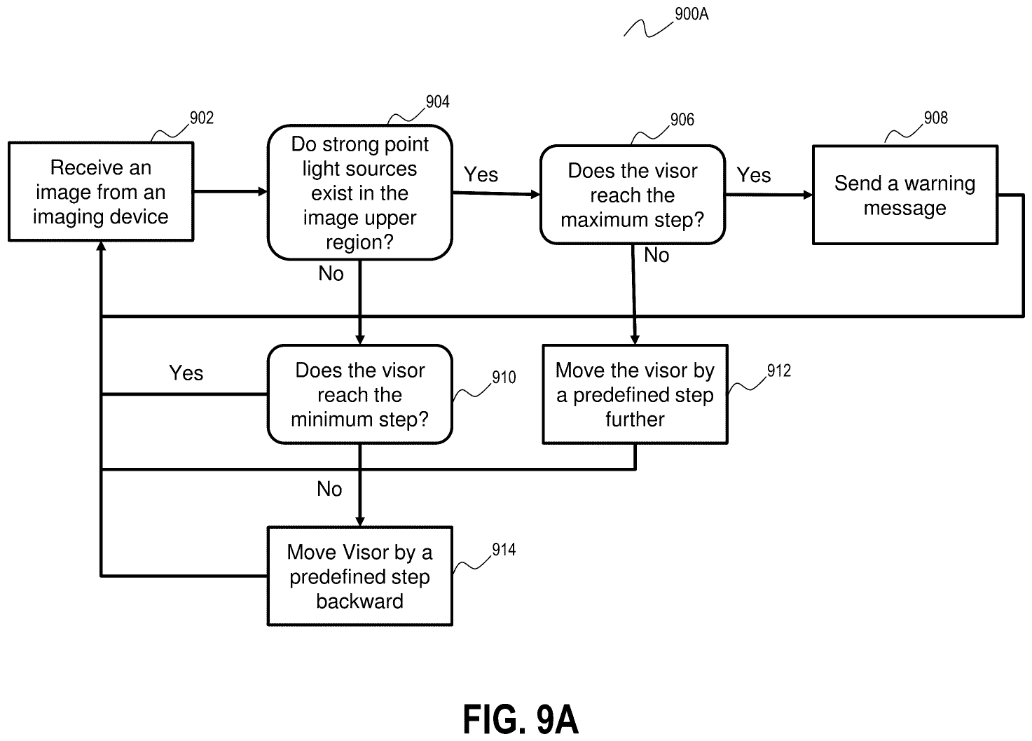

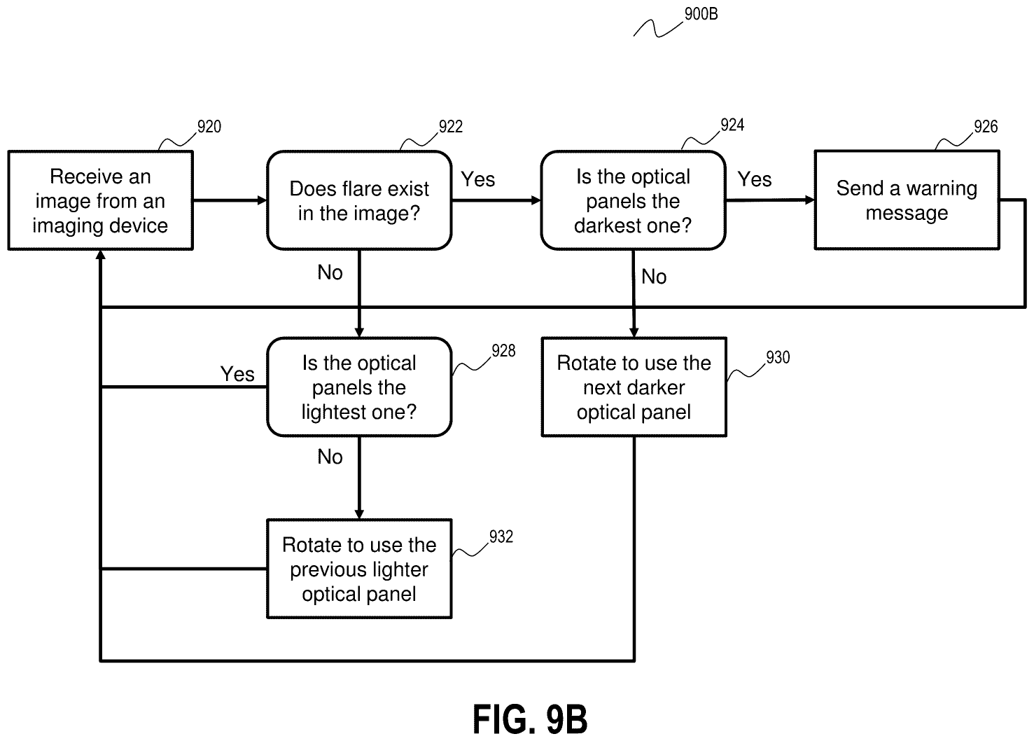

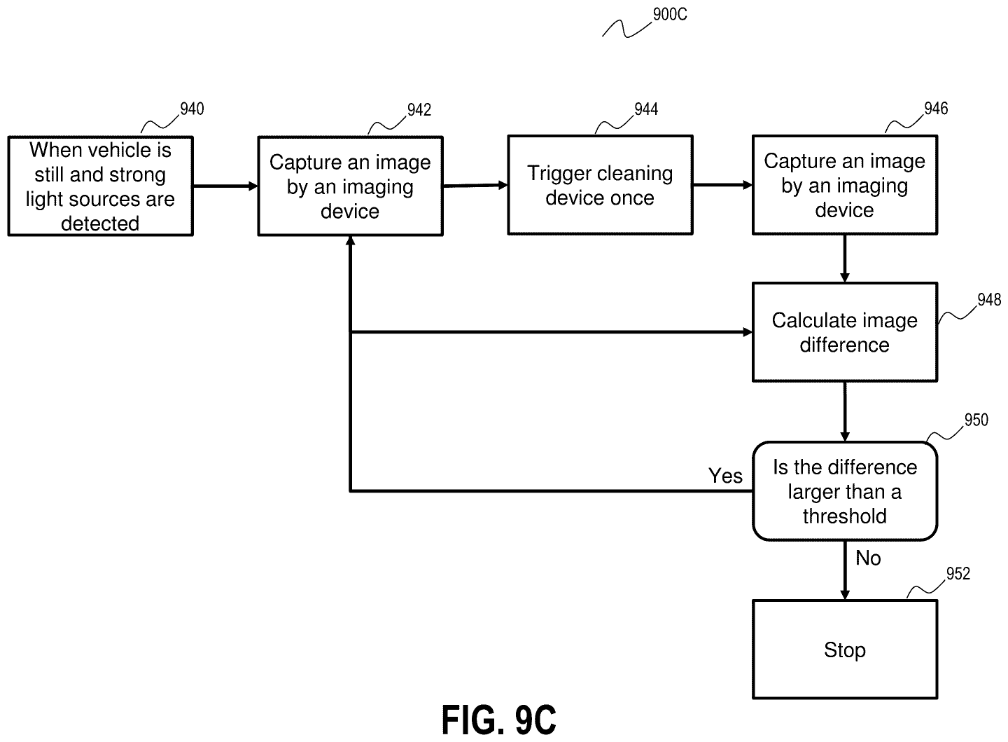

FIG. 9A is a flowchart of a process 900A for moving a visor for flare reduction for an imaging device. The process 900A can be implemented, for example, using the system 700, including visor 716, of FIGS. 7A and 7B, as well as other systems. The process 900A can begin at block 902 at which an image is received from an imaging device. At block 904, the image can be analyzed to determine whether strong point light source (e.g., indicative of flare) exist in an upper region of the image. The upper region may comprise for example, the top 10%, 20%, 25%, 30%, 33%, 40%, 50%, 60%, 66%, or 75% of the image. In some embodiments, to determine whether strong point light sources exist, the image is analyzed to determine whether regions of pixels (e.g., one or more pixels in the image are saturated, which can include being at the maximum brightness or intensity value (e.g., at 255 for an 8-bit pixel). In some embodiments, to determine whether strong point light sources exist, the image is analyzed to determine whether regions of pixels (e.g., one or more pixels) are significantly more brighter or more saturated than surrounding pixels. For example, this can include determining that a region of pixels is at least 2×, 3×, 4×, 5×, 10×, 15×, 20×, or 25× as bright as surrounding pixels.

Upon detecting that a strong point light source exists in an upper region of the image, at block 906, a current position of the visor can be determined. For example, the visor can be configured to move through a series of positional steps between a fully retracted position and a fully extended position. In some embodiments, if at block 906 it is determined that the visor is at its maximum step, at block 908 a warning message can be generated and/or displayed. If at block 906 it is determined that the visor is not at its maximum step, at block 912, the visor can be further extended by a predefined step, which can involve moving the visor one or more steps. The process 900A can be repeated for subsequently captured images.

If, at block 904, no strong point light source is identified in the upper region of the image, at block 910, the position of the visor can be determined. If, at block 910, it is determined that the visor has not reached its minimum step (e.g., its most retracted position), at block 914, the visor can be retracted by a predefined step, which can involve moving the visor one or more steps. The process 900A can be repeated for subsequently captured images.

In this way, images captured by the imaging device can be continuously or periodically analyzed to determine whether a flare exists which could be alleviated by movement of the visor. The visor is extended or retracted based on the image analysis.

FIG. 9B is a flowchart for a process 900B moving an optical panel for flare reduction for an imaging device. The process 900B can be implemented, for example, using the systems 600A, 600B, 600C, including optical panels 616, of FIGS. 6A-6C, as well as other systems. The process 900B begins at block 920 with receiving an image from an imaging device. At block 922, the image is analyzed to determine whether a flare exists within the image. In some embodiments, determination of whether a flare exists in the image can include determining the image histogram, calculating the percentage of pixels that are saturated, and, determining the presence of a flare when the percentage of pixels that are saturated is larger than a threshold value. The threshold value can be, for example, 10%, 20%, 30%, 40%, 50%, or other threshold values.

If no flare is detected at block 922, the process 900B moves to block 928, at which it is determined whether the lightest optical panel is currently positioned in front of the imaging device. If the lightest optical panel is not currently positioned in front of the imaging device, at block 932, the lightest optical panel is moved in front of the imaging device, and the process returns to block 920.

If flare is detected at block 922, the process moves to block 924 where it is determined whether the darkest optical panel is currently positioned in front of the imaging device. If the darkest optical panel is positioned in front of the imaging device, at block 926 a warning message can be generated and/or displayed. If at block 924 it is determined that the darkest optical panel is not positioned in front of the imaging device, then at block 930 the next darkest optical pane is moved into position in front of the imaging device.

In this way, the process 900B allows for continual or periodic analysis of images captured by the imaging device and moves lighter or darker optical panels in front of the imaging device depending on whether flare is detected within the images.

FIG. 9C is a flowchart for a process 900C for operating a cleaning device to clean an imaging device. The process 900C can be implemented with the systems 500A, 500B, which include cleaning devices 514, of FIGS. 5A and 5B or other systems. The process 900C begins at block 940. At block 940 it is determined whether the vehicle is still (e.g., stationary) and whether strong light sources exist in images captured by imaging devices of the vehicle. Determination of strong light sources can be determined as described above, for example, based on a threshold percentage of saturated pixels in the image histogram. In some embodiments, the process 900 can occur while the vehicle is in motion.

At block 942, a first image is captured by the imaging device. Next, at block 944 a cleaning device associated with the imaging device is triggered. Then, at block 946 a second image is captured. At block 948, the first and second images can be compared to determine a difference. The difference can be, for example, a difference in brightness, clarity, etc. At block 950, if the calculated difference exceeds a threshold, the process 944 returns to block 942 at which a new image is captured. The process 900C continues until the difference is less than the threshold, which can be indicative of the image device now being clean. The process 900C then concludes at block 952.

### EXAMPLES

Various example embodiments of the disclosure can be described by the following clauses:

Clause 1. A system comprising: a housing comprising at least one transparent window; an imaging device positioned within the housing, the imaging device comprising at least one image sensor and at least one lens, the imaging device positioned within the housing such that the imaging device captures images through the transparent window of the housing; and at least one cleaning device configured to clean the at least one transparent window.

Clause 2. The system of Clause 1, wherein the at least one cleaning device comprises a wiper and a motor configured to actuate the wiper to clean the at least one transparent window.

Clause 3. The system of Clause 1, wherein the at least one cleaning device comprises at least one nozzle coupled to a source of pressurized gas, wherein the at least one nozzle is oriented to direct at least one jet of gas toward the transparent window to clean the transparent window.

Clause 4. The system of any of Clauses 1-3, further comprising at least one optical panel configured to be moved from a first position in front of the lens of the imaging device and a second position different than the first position.

Clause 5. The system of Clause 4, wherein the at least one optical panel comprises at least one optical property that is different than a corresponding optical property of the Clause 6. The system of any of Clauses 4 or 5, wherein the at least one optical panel comprises at least one of tinted glass or tinted plastic.

Clause 7. The system of any of Clauses 4-6, wherein the at least one optical panel comprises at least one of an anti-glare coating or a photochromatic coating.

Clause 8. The system of any of Clauses 4-7, wherein the at least one optical panel comprises: a first optical panel; and a second optical panel, wherein at least one optical property of the second optical panel is different than a corresponding optical property of the first optical panel.

Clause 9. The system of any of Clauses 1-8, further comprising at least one visor configured to move between a first position and a second position.

Clause 10. The system of any of Clauses 1-9, wherein an interior of the housing is configured to receive at least one of temperature-controlled air or humidity controlled air from a source external to the housing.

Clause 11. A system comprising: a housing comprising at least one transparent window; an imaging device positioned within the housing, the imaging device comprising at least one image sensor and at least one lens, the imaging device positioned within the housing such that the imaging device captures images through the transparent window; and at least one optical panel configured to be moved from a first position in front of the lens of the imaging device and a second position different than the first position.

Clause 12. The system of Clause 11, wherein the at least one optical panel is configured to be rotated between the first position and the second position.

Clause 13. The system of Clause 11, wherein the at least one optical panel is positioned in a track and configured to be moved linearly along the track between the first position and the second position.

Clause 14. The system of any of Clauses 11-13, wherein the at least one optical panel comprises at least one optical property that is different than a corresponding optical property of the transparent window.

Clause 15. The system of any of Clauses 11-14, wherein the at least one optical panel comprises at least one Clause of tinted glass or tinted plastic.

Clause 16. The system of any of Clauses 11-15, wherein the at least one optical panel comprises at least one of an anti-glare coating or a photochromatic coating.

Clause 17. The system of any of Clauses 11-16 wherein the at least one optical panel comprises: a first optical panel; and a second optical panel, wherein at least one optical property of the second optical panel is different than a corresponding optical property of the first optical panel.

Clause 18. The system of any of Clauses 11-17, further comprising at least one cleaning device configured to clean the at least one transparent window.

Clause 19. The system of Clause 18, wherein the at least one cleaning device comprises a wiper and a motor configured to actuate the wiper to clean the at least one transparent window.

Clause 20. The system of Clause 18, wherein the at least one cleaning device comprises at least one nozzle coupled to a source of pressurized gas, wherein the at least one nozzle is oriented to direct at least one jet of gas toward the transparent window to clean the transparent window.

Clause 21. The system of any of Clauses 11-20, further comprising at least one visor configured to move between a first position and a second position.

Clause 22. The system of any of Clauses 11-21, wherein an interior of the housing is configured to receive at least one of temperature-controlled air or humidity controlled air from a source external to the housing.

Clause 23. A system, comprising: at least one processor; and at least one memory storing instructions thereon that, when executed by the at least one processor, cause the at least one processor to: receive at least one image from an imaging device; analyze the at least on image to determine a presence of an optical flare within the at least one image; and based on the presence of an optical flare within the at least one image, cause at least one optical panel to be moved into a position in front of a lens of the imaging device.

Clause 24. The system of Clause 23, wherein the at least one optical panel is configured to be rotated between a first position in front of the lens of the imaging device and a second position.

Clause 25. The system of Clause 23, wherein the at least one optical panel is positioned in a track and configured to be moved linearly along the track between a first position in front of the lens and a second position.

Clause 26. The system of any of Clauses 23-25, wherein the at least one optical panel comprises at least one optical property that is different than a corresponding optical property of the transparent window.

Clause 27. The system of any of Clauses 23-26, wherein the at least one optical panel comprises at least one of tinted glass or tinted plastic.

Clause 28. The system of any of Clauses 23-27, wherein the at least one optical panel comprises at least one of an anti-glare coating or a photochromatic coating.

Clause 29. The system of any of Clauses 23-28, wherein the at least one optical panel comprises: a first optical panel; and a second optical panel, wherein at least one optical property of the second optical panel is different than a corresponding optical property of the first optical panel.

Clause 30. The system of any of Clauses 23-29, wherein the processor is further configured to: analyze the at least one image to determine a cleanliness state of a transparent window through which the imaging device captured the at least one image; and based on the cleanliness state, cause a cleaning device to clean the transparent window.

Clause 31. The system of Clause 30, wherein the at least one cleaning device comprises a wiper and a motor configured to actuate the wiper to clean the at least one transparent window.

Clause 32. The system of Clause 30, wherein the at least one cleaning device comprises at least one nozzle coupled to a source of pressurized gas, wherein the at least one nozzle is oriented to direct at least one jet of gas toward the transparent window to clean the transparent window.

Clause 33. A method, comprising: receiving, by a processor, at least one image from an imaging device; analyzing, by the processor, the at least on image to determine a presence of an optical flare within the at least one image; and based on the presence of an optical flare within the at least one image, causing, by the processor, at least one optical panel to be moved into a position in front of a lens of the imaging device.

Clause 34. The method of Clause 33, wherein the at least one optical panel is configured to be rotated between a first position in front of the lens of the imaging device and a second position.

Clause 35. The method of Clause 33, wherein the at least one optical panel is positioned in a track and configured to be moved linearly along the track between a first position in front of the lens and a second position.

Clause 36. The method of any of Clauses 33-35, wherein the at least one optical panel comprises at least one optical property that is different than a corresponding optical property of the transparent window.

Clause 37. The method of any of Clauses 33-36, wherein the at least one optical panel comprises at least one of tinted glass or tinted plastic.

Clause 38. The method of any of Clauses 33-37, wherein the at least one optical panel comprises at least one of an anti-glare coating or a photochromatic coating.

Clause 39. The method of any of Clauses 33-38, further comprising: analyzing, by the processor, the at least one image to determine a cleanliness state of a transparent window through which the imaging device captured the at least one image; and based on the cleanliness state, causing, by the processor, a cleaning device to clean the transparent window.

Clause 40. The method of Clause 39, wherein the at least one cleaning device comprises a wiper and a motor configured to actuate the wiper to clean the at least one transparent window.

Clause 41. The method of Clause 39, wherein the at least one cleaning device comprises at least one nozzle coupled to a source of pressurized gas, wherein the at least one nozzle is oriented to direct at least one jet of gas toward the transparent window to clean the transparent window.

Clause 42. A method, comprising receiving, by a processor, at least one image from an imaging device; analyzing, by the processor, the at least on image to determine a cleanliness state of a transparent window through which the imaging device captured the at least one image; and based on the cleanliness state, causing, by the processor, a cleaning device to clean the transparent window.

Clause 43. The method of Clause 42, wherein the at least one cleaning device comprises a wiper and a motor configured to actuate the wiper to clean the at least one transparent window.

Clause 44. The method of Clause 42, wherein the at least one cleaning device comprises at least one nozzle coupled to a source of pressurized gas, wherein the at least one nozzle is oriented to direct at least one jet of gas toward the transparent window to clean the transparent window.

### ADDITIONAL EXAMPLES

All of the methods and tasks described herein may be performed and fully automated by a computer system. The computer system may, in some cases, include multiple distinct computers or computing devices (e.g., physical servers, workstations, storage arrays, cloud computing resources, etc.) that communicate and interoperate over a network to perform the described functions. Each such computing device typically includes a processor (or multiple processors) that executes program instructions or modules stored in a memory or other non-transitory computer-readable storage medium or device (e.g., solid state storage devices, disk drives, etc.). The various functions disclosed herein may be embodied in such program instructions or may be implemented in application-specific circuitry (e.g., ASICs or FPGAs) of the computer system. Where the computer system includes multiple computing devices, these devices may, but need not, be co-located. The results of the disclosed methods and tasks may be persistently stored by transforming physical storage devices, such as solid-state memory chips or magnetic disks, into a different state. In some embodiments, the computer system may be a cloud-based computing system whose processing resources are shared by multiple distinct business entities or other users.

The processes described herein or illustrated in the figures of the present disclosure may begin in response to an event, such as on a predetermined or dynamically determined schedule, on demand when initiated by a user or system administrator, or in response to some other event. When such processes are initiated, a set of executable program instructions stored on one or more non-transitory computer-readable media (e.g., hard drive, flash memory, removable media, etc.) may be loaded into memory (e.g., RAM) of a server or other computing device. The executable instructions may then be executed by a hardware-based computer processor of the computing device. In some embodiments, such processes or portions thereof may be implemented on multiple computing devices and/or multiple processors, serially or in parallel.

Depending on the embodiment, certain acts, events, or functions of any of the processes or algorithms described herein can be performed in a different sequence, can be added, merged, or left out altogether (e.g., not all described operations or events are necessary for the practice of the algorithm). Moreover, in certain embodiments, operations or events can be performed concurrently, e.g., through multi-threaded processing, interrupt processing, or multiple processors or processor cores or on other parallel architectures, rather than sequentially.

The various illustrative logical blocks, modules, routines, and algorithm steps described in connection with the embodiments disclosed herein can be implemented as electronic hardware (e.g., ASICs or FPGA devices), computer software that runs on computer hardware, or combinations of both. Moreover, the various illustrative logical blocks and modules described in connection with the embodiments disclosed herein can be implemented or performed by a machine, such as a processor device, a digital signal processor (“DSP”), an application specific integrated circuit (“ASIC”), a field programmable gate array (“FPGA”) or other programmable logic device, discrete gate or transistor logic, discrete hardware components, or any combination thereof designed to perform the functions described herein. A processor device can be a microprocessor, but in the alternative, the processor device can be a controller, microcontroller, or state machine, combinations of the same, or the like. A processor device can include electrical circuitry configured to process computer-executable instructions. In another embodiment, a processor device includes an FPGA or other programmable device that performs logic operations without processing computer-executable instructions. A processor device can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor device may also include primarily analog components. For example, some or all of the rendering techniques described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

The elements of a method, process, routine, or algorithm described in connection with the embodiments disclosed herein can be embodied directly in hardware, in a software module executed by a processor device, or in a combination of the two. A software module can reside in RAM memory, flash memory, ROM memory, EPROM memory, EEPROM memory, registers, hard disk, a removable disk, a CD-ROM, or any other form of a non-transitory computer-readable storage medium. An exemplary storage medium can be coupled to the processor device such that the processor device can read information from, and write information to, the storage medium. In the alternative, the storage medium can be integral to the processor device. The processor device and the storage medium can reside in an ASIC. The ASIC can reside in a user terminal. In the alternative, the processor device and the storage medium can reside as discrete components in a user terminal.

In the foregoing description, aspects and embodiments of the present disclosure have been described with reference to numerous specific details that can vary from implementation to implementation. Accordingly, the description and drawings are to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction. Any definitions expressly set forth herein for terms contained in such claims shall govern the meaning of such terms as used in the claims. In addition, when we use the term “further comprising,” in the foregoing description or following claims, what follows this phrase can be an additional step or entity, or a sub-step/sub-entity of a previously recited step or entity.

1. A system comprising:
a housing comprising at least one transparent window;
an imaging device positioned within the housing, the imaging device comprising at least one image sensor and at least one lens, the imaging device positioned within the housing such that the imaging device captures images through the transparent window of the housing; and
at least one cleaning device configured to clean the at least one transparent window.

2. The system of claim 1, wherein the at least one cleaning device comprises a wiper and a motor configured to actuate the wiper to clean the at least one transparent window.

3. The system of claim 1, wherein the at least one cleaning device comprises at least one nozzle coupled to a source of pressurized gas, wherein the at least one nozzle is oriented to direct at least one jet of gas toward the transparent window to clean the transparent window.

4. The system of claim 1, further comprising at least one optical panel configured to be moved from a first position in front of the lens of the imaging device and a second position different than the first position.

5. The system of claim 4, wherein the at least one optical panel comprises at least one optical property that is different than a corresponding optical property of the transparent window.

6. The system of claim 4, wherein the at least one optical panel comprises at least one of tinted glass or tinted plastic.

7. The system of claim 4, wherein the at least one optical panel comprises at least one of an anti-glare coating or a photochromatic coating.

8. The system of claim 4, wherein the at least one optical panel comprises:
a first optical panel; and
a second optical panel, wherein at least one optical property of the second optical panel is different than a corresponding optical property of the first optical panel.

9. The system of claim 1, further comprising at least one visor configured to move between a first position and a second position.

10. The system of claim 1, wherein an interior of the housing is configured to receive at least one of temperature controlled air or humidity controlled air from a source external to the housing.

11. (canceled)

12. (canceled)

13. (canceled)

14. (canceled)

15. (canceled)

16. (canceled)

17. (canceled)

18. (canceled)

19. (canceled)

20. (canceled)

21. (canceled)

22. (canceled)

23. A system, comprising:
at least one processor; and
at least one memory storing instructions thereon that, when executed by the at least one processor, cause the at least one processor to:
receive at least one image from an imaging device;
analyze the at least on image to determine a presence of an optical flare within the at least one image; and
based on the presence of an optical flare within the at least one image, cause at least one optical panel to be moved into a position in front of a lens of the imaging device.

24. The system of claim 23, wherein the at least one optical panel is configured to be rotated between a first position in front of the lens of the imaging device and a second position.

25. The system of claim 23, wherein the at least one optical panel is positioned in a track and configured to be moved linearly along the track between a first position in front of the lens and a second position.

26. The system of claim 23, wherein the at least one optical panel comprises at least one optical property that is different than a corresponding optical property of the transparent window.

27. The system of claim 23, wherein the at least one optical panel comprises at least one of tinted glass or tinted plastic.

28. The system of claim 23, wherein the at least one optical panel comprises at least one of an anti-glare coating or a photochromatic coating.

29. The system of claim 23, wherein the at least one optical panel comprises:
a first optical panel; and
a second optical panel, wherein at least one optical property of the second optical panel is different than a corresponding optical property of the first optical panel.

30. The system of claim 23, wherein the processor is further configured to:
analyze the at least one image to determine a cleanliness state of a transparent window through which the imaging device captured the at least one image; and
based on the cleanliness state, cause a cleaning device to clean the transparent window.

31. The system of claim 30, wherein the at least one cleaning device comprises a wiper and a motor configured to actuate the wiper to clean the at least one transparent window.

32. The system of claim 30, wherein the at least one cleaning device comprises at least one nozzle coupled to a source of pressurized gas, wherein the at least one nozzle is oriented to direct at least one jet of gas toward the transparent window to clean the transparent window.

33. A method, comprising:
receiving, by a processor, at least one image from an imaging device;
analyzing, by the processor, the at least on image to determine a presence of an optical flare within the at least one image; and
based on the presence of an optical flare within the at least one image, causing, by the processor, at least one optical panel to be moved into a position in front of a lens of the imaging device.

34. (canceled)

35. (canceled)

36. (canceled)

37. (canceled)

38. (canceled)

39. (canceled)

40. (canceled)

41. (canceled)

42. (canceled)

43. (canceled)

44. (canceled)
